(19) United States
(12) Patent Application Publication
(10) Pub. No.: US 2026/0253809 A1
(43) Pub. Date: Aug. 27, 2026

(54) Solid Electrolytic Capacitor With Barrier Coating

(71) Applicant: KYOCERA AVX Components Corporation, Fountain Inn, SC (US)

(72) Inventors: Craig Nies, Travelers Rest, SC (US); Miloslav Uher, Lanskroun (CZ); Quan Shi, Greer, SC (US); Jan Petrzilek, Usti nad Orlici (CZ); Jiri Navratil, Veseli nad Moravou (CZ); Romana Sulakova, Usti nad Orlici (CZ); Sucheera Kanchanavatthanakit, Bangkok (TH)

(21) Appl. No.: 19/551,767

(22) Filed: Feb. 27, 2026

Related U.S. Application Data
(60) Provisional application No. 63/764,067, filed on Feb. 27, 2025.

(51) Int. Cl. H01G 9/012; H01G 9/15

(52) U.S. Cl. CPC H01G 9/012; H01G 9/15

(57) ABSTRACT

A solid electrolytic capacitor comprising a capacitor element, anode lead extending from a surface of the capacitor element, an anode termination that is in electrical connection with the anode lead, a cathode termination that is in electrical connection with the solid electrolyte, and a casing material that encapsulates the capacitor element and anode lead is provided. A barrier coating is disposed adjacent to at least a portion of the cathode termination and/or anode termination. The coating contains a hydrophobic resinous material containing a hydrocarbon polymer. The resinous material has a per-and polyfluoroalkyl substance content of about 50 ppm or less and a gelation point of about 60° C. to about 250° C.

### RELATED APPLICATION

The present application is based upon and claims priority to U.S. Provisional Patent Application Ser. No. 63/764,067, having a filing date of Feb. 27, 2025, which is incorporated herein by reference.

### BACKGROUND OF THE INVENTION

Electrolytic capacitors (e.g., tantalum capacitors) are increasingly being used in the design of circuits due to their volumetric efficiency, reliability, and process compatibility. For example, one type of capacitor that has been developed is a solid electrolytic capacitor that includes a tantalum anode, dielectric layer, and conductive polymer solid electrolyte. To help protect the capacitor from the exterior environment and provide it with good mechanical stability, the capacitor element is often also encapsulated with a casing material (e.g., epoxy resin) so that a portion of the anode and cathode terminations remain exposed for mounting to a surface. Additionally, some capacitor elements are also covered with a barrier coating to help prevent delamination of the casing material and to help maintain the electrical properties of the capacitor, even when exposed to high temperatures. Unfortunately, many problems remain with the application of the barrier coating. For instance, the barrier coating may often be molded over the capacitor element, and often issues may occur during the “overmolding” process of the barrier coating. Such issues include poor or uneven application, incomplete molding, and even bleed out, as some of the substances within the coating may migrate to the surface due to poor compatibility. As such, a need exists for an improved barrier coating that is capable of exhibiting better overmolding and adhesion properties.

### SUMMARY OF THE INVENTION

In accordance with one embodiment of the present invention, a solid electrolytic capacitor is disclosed that comprises a capacitor element that contains an anode body, a dielectric that overlies the anode body, and a solid electrolyte that overlies the dielectric; an anode lead extending from a surface of the capacitor element; an anode termination that is in electrical connection with the anode lead; a cathode termination that is in electrical connection with the solid electrolyte; and a casing material that encapsulates the capacitor element and anode lead. A barrier coating is disposed adjacent to at least a portion of the cathode termination and/or anode termination. The coating comprises a resinous material containing a hydrocarbon polymer, wherein the resinous material has a per- and polyfluoroalkyl substance content of about 50 ppm or less and a gelation point of about 60° C. to about 250° C.

Other features and aspects of the present invention are set forth in greater detail below.

### BRIEF DESCRIPTION OF THE DRAWING

A full and enabling disclosure of the present invention, including the best mode thereof, directed to one of ordinary skill in the art, is set forth more particularly in the remainder of the specification, which makes reference to the appended drawing in which:

FIG. 1 is a schematic illustration of one embodiment of a solid electrolytic capacitor that may be formed in accordance with the present invention;

FIG. 2 is a schematic illustration of one embodiment of a solid electrolytic capacitor that may be formed in accordance with the present invention;

FIG. 3 is a schematic illustration of one embodiment of a solid electrolytic capacitor that may be formed in accordance with the present invention;

FIG. 4 is a schematic illustration of one embodiment of a solid electrolytic capacitor that may be formed in accordance with the present invention;

FIG. 5 is the DMA curve of the barrier coating of Comparative Example 1;

FIG. 6 is the DMA curve of the barrier coating of Comparative Example 2;

FIG. 7 is the DMA curve of the barrier coating of Comparative Example 3;

FIG. 8 is a graph demonstrating the log complex viscosities of Comparative Examples 1-3:

FIG. 9 is the DMA curve of the barrier coating of Example 1;

FIG. 10 is the DMA curve of the barrier coating of Example 2;

FIG. 11 is the DMA curve of the barrier coating of Example 3;

FIG. 12 is the DMA curve of the barrier coating of Example 4;

FIG. 13 is the DMA curve of the barrier coating of Example 5;

FIG. 14 is the DMA curve of the barrier coating of Example 6;

FIG. 15 is a graph demonstrating the log complex viscosities of Examples 1-6.

Repeat use of references characters in the present specification and drawing is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only and is not intended as limiting the broader aspects of the present invention, which broader aspects are embodied in the exemplary construction.

Generally speaking, the present invention is directed to a solid electrolytic capacitor that contains a capacitor element including an anode body, dielectric overlying the anode body, and solid electrolyte overlying the dielectric. An anode lead extends from the anode body and is in electrical contact with an anode termination. A cathode termination is likewise in electrical contact with the solid electrolyte. Further, a casing material encapsulates the capacitor element and anode lead and leaves exposed at least a portion of the anode termination and cathode termination for external contact. A barrier coating is also employed in the capacitor that is disclosed adjacent to at least a portion of the cathode termination and/or anode termination.

Notably, the barrier coating contains a resinous material that demonstrates a low gelation point. Generally, a low gelation point may indicate that the resinous material may have improved moldability and enhanced encapsulation capabilities. The gelation point is considered to be the point (e.g., temperature) where the storage modulus (G′) of the resinous material and the loss modulus (G″) of the resinous material become equal. Thus, the gelation point may be the point where the two moduli intersect on a graph. When the storage modulus (G′) is greater than the loss modulus (G″), the resinous material may demonstrate more solid-like properties, as more energy is being stored elastically. However, when the loss modulus (G″) is greater than the storage modulus (G′), the resinous material may demonstrate more liquid-like behavior, as more energy is being lost as heat than stored elastically. Without intending to be limited by theory, the present inventors have found that selectively controlling the gelation point of the resinous material can result in other benefits to the resulting capacitor. For example, a resinous material having a certain gelation point can help minimize cracking of the capacitor during the process of applying the casing material, often known as “overmolding.”

In certain embodiments, the resinous material may have a gelation point of from about 60° C. to about 250° C., such as from about 70° C. to about 225° C., such as from about 80° C. to about 200° C., such as from about 80° C. to about 185° C., such as from about 120° C. to about 185° C. Additionally, while exhibiting the low gelation point and overmolding properties noted above, the present inventors have also discovered that the composition may be relatively free of halogens. Therefore, not only may the barrier coatings of the present disclosure provide improved mechanical properties, but they also may provide many other environmental benefits as well.

In addition to demonstrating the desired low gelation point and increased liquid-like behavior during the overmolding process, the resinous material may also demonstrate other beneficial properties. For instance, in certain embodiments, the resinous material may also demonstrate a unique viscosity profile that allows the barrier coating to demonstrate predominantly liquid behavior when exposed to the high temperatures often experienced during manufacturing of the capacitor (e.g., reflow). Without intending to be limited by theory, it is believed that the predominantly liquid behavior may help the resulting capacitor to buffer the mechanical and thermal strains placed on the capacitor during manufacturing (e.g., reflow), as the unique viscosity profile provides the barrier coating with improved flexibility and elasticity. Therefore, it is believed that the enhanced viscoelastic properties of the resinous material within the barrier coating may help prevent the resulting capacitors from cracking or delaminating during reflow, which results in better protection from moisture and oxygen, and thus more reliable capacitors. Therefore, the resinous material as described herein may help provide the barrier coating with improved flexibility and elasticity during both the application of the casing material (e.g., overmolding) and later during manufacturing (e.g., reflow).

In certain embodiments, the unique viscosity profile that allows the barrier coating to demonstrate predominantly liquid behavior when exposed to the high temperatures experienced during manufacturing of the capacitor (e.g., reflow) may be characterized by having a certain “log complex viscosity” (i.e., log₁₀ of the complex viscosity (Pa-s)) at the high temperatures experienced during reflow. For example, the log complex viscosity may be about 3 or less, in some embodiments about 2.5 or less, in some embodiments about 2.3 or less, in some embodiments about 2 or less, in some embodiments about 1.8 or less in some embodiments about 1.5 or less, in some embodiments about 1 or less, and in some embodiments, from about 0.01 to about 0.6 at high temperatures, such as from about such as from about 225° C. to about 270° C., in some embodiments from about 230° C. to about 265° C., in some embodiments from about 235° C. to about 260° C., and in some embodiments, from about 245° C. to about 255° C. In one particular embodiment, for example, the resinous material may exhibit a log complex viscosity within the ranges noted above at a temperature of about 250° C. The actual complex viscosity may also be about 200 Pa·s or less at the high temperatures noted above, such as about 100 Pa·s or less, such as about 50 Pa·s or less, such as about 25 Pa·s or less, such as about 10 P·s or less, such as about 5 Pa·s or less, and generally greater than about 2 Pa·s or more, such as about 3 Pa·s or more, such as about 4 Pa·s or more at a temperature of about 200° C. or more.

The resinous material may also have a glass transition temperature such that the flexibility of the resulting barrier coating is not substantially restricted. For instance, the glass transition temperature (“T_{g}”) of the resinous material may be from about 35° C. to about 80° C., such as about 40° C. to about 75° C., and even about 42° C. to about 70° C., such as determined with dynamic mechanical analysis in accordance with ISO 6721-11:2019 and/or ASTM D4065-20. Additionally, the resinous material may have a thermal decomposition temperature (“T_{d}”), indicating the temperature at which the resinous material chemically breaks down, of from about 205° C. to about 290° C., such as from about 210° C. to about 280° C., such as from about 215° C. to about 270° C., such as determined when the material loses 5% of its mass during thermogravimetric analysis in accordance with ISO 11358-1:2022 and/or ASTM Test E 1131-20.

In certain embodiments, the resinous material may be considered “hydrophobic,” which generally refers to any material that has a surface free energy such that it is not wettable by an aqueous medium. For example, the material may have an advancing and/or receding contact angle with water of about 75° to about 120°, such as about 80° to about 115°, such as about 85° to about 110°, such as about 90° to about 105°, such as determined in accordance with ASTM D5946-17. Due to the low surface energy of such hydrophobic materials, the barrier layer can become highly resistant to moisture and thus inhibit its passage into the capacitor element.

As noted above, one benefit of the unique nature of the resinous material is that it can achieve the beneficial properties noted above without requiring the use of fluorinated materials often employed in conventional barrier coatings. In this regard, the resulting resinous material may have a per- and polyfluoroalkyl substance content of about 50 ppm or less, such as about 25 ppm or less, such as about 10 ppm or less, such as about 5 ppm or less. In certain embodiments, the resinous material may be substantially free of per-and polyfluoroalkyl substances. For instance, in certain embodiments, the resinous material may have a content of a fully fluorinated carbon, such as a fully fluorinated methyl or methylene without any hydrogen, chlorine, bromine, and/or iodine atoms attached, of about 50 ppm or less, such as about 25 ppm or less, such as about 10 ppm or less, such as about 5 ppm or less. Thus, in certain embodiments, the resinous material may have a per-and polyfluoroalkyl substance (e.g., a fully fluorinated carbon) content of about 25 ppb to about 50 ppm, such as about 250 ppb to about 15 ppm, and even such as about 500 ppb to about 5 ppm.

In other embodiments, the resulting resinous material may have a low content of halogens (e.g., fluorine, chlorine, bromine, etc.), such as about 500 ppm or less, such as about 400 ppm or less, such as about 300 ppm or less, such as about 200 ppm or less, such as about 150 ppm or less, such as about 100 ppm or less, such as about 75 ppm or less, such as about 50 ppm or less, such as about 25 ppm or less, such as about 10 ppm or less, and even such as about 5 ppm or less. In certain embodiments, the resinous material has a halogen content of about 25 ppb to about 500 ppm, such as about 250 ppb to about 100 ppm, and even such as about 500 ppb to about 50 ppm. Thus, in some embodiments, the resinous material may be substantially free of halogens, such that it has 50 ppm or less of halogen content.

Through selective control over the particular nature of the barrier coating, the application of the barrier coating may be improved, resulting in a capacitor that can exhibit excellent electrical properties. For example, the capacitor may exhibit a relatively low equivalence series resistance (“ESR”), such as about 200 mohms or less, in some embodiments less than about 150 mohms, in some embodiments from about 0.1 to about 125 mohms, and in some embodiments, from about 1 to about 100 mohms, measured at an operating frequency of 100 kHz and temperature of 23° C. The capacitor may also exhibit a dry capacitance of about 30 nanoFarads per square centimeter (“nF/cm²”) or more, in some embodiments about 100 nF/cm² or more, in some embodiments from about 200 to about 3,000 nF/cm2, and in some embodiments, from about 400 to about 2,000 nF/cm², measured at a frequency of 120 Hz at temperature of 23° C. In addition, the capacitor may also exhibit a DCL of only about 50 microamps (“μA”) or less, in some embodiments about 40 μA or less, in some embodiments about 20 μA or less, and in some embodiments, from about 0.1 to about 10 μA as determined at a temperature of 23° C.

Notably, such electrical properties (e.g., ESR, capacitance, and/or DCL) can still remain stable even at high temperatures. For example, the capacitor may exhibit ESR, capacitance, or DCL values within the ranges noted above even after being exposed to a temperature of from about 80° C. or more, in some embodiments from about 100° C. to about 200° C., and in some embodiments, from about 105° C. to about 180° C. (e.g., 85° C., 105° C., 125° C., or 150° C.) for a substantial period of time, such as for about 100 hours or more, in some embodiments from about 150 hours to about 5,000 hours, and in some embodiments, from about 200 hours to about 3,500 hours (e.g., 3,000 hours). In one embodiment, for example, the ratio of the ESR and/or capacitance value of the capacitor after being exposed to the high temperature (e.g., 150° C.) for 3,000 hours to the initial ESR and/or capacitance value of the capacitor (e.g., at 23° C.) is about 0.5 or more, in some embodiments about 0.7 or more, in some embodiments from about 0.8 to 1, and in some embodiments, from about 0.9 to 1. Likewise, the ratio of the DCL of the capacitor after being exposed to a high temperature (e.g., 85° C.) for 3,000 hours to the initial DCL value of the capacitor (e.g., at 23° C.) is about 1.5 or less, in some embodiments about 1.3 or less, in some embodiments from about 0.6 to about 1.2, and in some embodiments, from about 0.8 to about 1.1.

The capacitor may also exhibit ESR, capacitance, or DCL values within the ranges noted above after being exposed to a high relative humidity level, either at room temperature (23° C.) or a high temperature as noted above (e.g., 85° C., 125° C., or 150° C.). Such high relative humidity levels may, for instance, be about 40% or more, in some embodiments about 45% or more, in some embodiments about 50% or more, and in some embodiments, about 70% or more (e.g., about 85% to 100%) for a substantial period of time as noted above. Relative humidity may, for instance, be determined in accordance with ASTM E337-02, Method A (2007). In one embodiment, for example, the ratio of the DCL value of the capacitor after being exposed to high humidity (e.g., 85%) for 3,000 hours to the initial DCL value of the capacitor is about 1.5 or less, in some embodiments about 1.3 or less, in some embodiments from about 0.6 to about 1.2, and in some embodiments, from about 0.8 to about 1.1.

Various embodiments of the capacitor will now be described in more detail.

### 1. Capacitor Element

### A. Anode Body

The capacitor element typically includes an anode that contains a dielectric formed on an anode body. The anode body may be in the form of a sheet, foil, mesh, pellet, etc. Regardless of its form, the anode body is typically formed from a powder that contains a valve metal (i.e., metal that is capable of oxidation) or valve metal-based compound, such as tantalum, niobium, aluminum, hafnium, titanium, alloys thereof, oxides thereof, nitrides thereof, and so forth. In one embodiment, for instance, the anode body may be in the form of a foil that contains aluminum. In another embodiment, the anode body may be in the form of a pellet that contains tantalum, niobium, or an oxide thereof. A tantlum powder, for instance, may be formed from a reduction process in which a tantalum salt (e.g., potassium fluorotantalate (K₂TaF₇), sodium fluorotantalate (Na₂TaF₇), tantalum pentachloride (TaCl₅), etc.) is reacted with a reducing agent. The reducing agent may be provided in the form of a liquid, gas (e.g., hydrogen), or solid, such as a metal (e.g., sodium), metal alloy, or metal salt. In one embodiment, for instance, a tantalum salt (e.g., TaCl₅) may be heated at a temperature of from about 900° C. to about 2,000° C., in some embodiments from about 1,000° C. to about 1,800° C., and in some embodiments, from about 1,100° C. to about 1,600° C., to form a vapor that can be reduced in the presence of a gaseous reducing agent (e.g., hydrogen). Additional details of such a reduction reaction may be described in WO 2014/199480 to Maeshima, et al. After the reduction, the product may be cooled, crushed, and washed to form a powder.

The specific charge of the powder typically varies from about 2,000 to about 600,000 microFarads*Volts per gram (“μF*V/g”) depending on the desired application. For instance, in certain embodiments, a high charge powder may be employed that has a specific charge of from about 100,000 to about 550,000 μF*V/g, in some embodiments from about 120,000 to about 500,000 μF*V/g, and in some embodiments, from about 150,000 to about 400,000 μF*V/g. In other embodiments, a low charge powder may be employed that has a specific charge of from about 2,000 to about 100,000 μF*V/g, in some embodiments from about 5,000 to about 80,000 μF*V/g, and in some embodiments, from about 10,000 to about 70,000 μF*V/g. As is known in the art, the specific charge may be determined by multiplying capacitance by the anodizing voltage employed, and then dividing this product by the weight of the anodized electrode body.

The powder may be a free-flowing, finely divided powder that contains primary particles. The primary particles of the powder generally have a median size (D50) of from about 5 to about 500 nanometers, in some embodiments from about 10 to about 400 nanometers, and in some embodiments, from about 20 to about 250 nanometers, such as determined using a laser particle size distribution analyzer made by BECKMAN COULTER Corporation (e.g., LS-230), optionally after subjecting the particles to an ultrasonic wave vibration of 70 seconds. The primary particles typically have a three-dimensional granular shape (e.g., nodular or angular). Such particles typically have a relatively low “aspect ratio”, which is the average diameter or width of the particles divided by the average thickness (“D/T”). For example, the aspect ratio of the particles may be about 4 or less, in some embodiments about 3 or less, and in some embodiments, from about 1 to about 2. In addition to primary particles, the powder may also contain other types of particles, such as secondary particles formed by aggregating (or agglomerating) the primary particles. Such secondary particles may have a median size (D50) of from about 1 to about 500 micrometers, and in some embodiments, from about 10 to about 250 micrometers.

Agglomeration of the particles may occur by heating the particles and/or through the use of a binder. For example, agglomeration may occur at a temperature of from about 0° C. to about 40° C., in some embodiments from about 5° C. to about 35° C., and in some embodiments, from about 15° C. to about 30° C. Suitable binders may likewise include, for instance, poly(vinyl butyral); poly(vinyl acetate); poly(vinyl alcohol); poly(vinyl pyrollidone); cellulosic polymers, such as carboxymethylcellulose, methyl cellulose, ethyl cellulose, hydroxyethyl cellulose, and methylhydroxyethyl cellulose; atactic polypropylene, polyethylene; polyethylene glycol (e.g., Carbowax from Dow Chemical Co.); polystyrene, poly(butadiene/styrene); polyamides, polyimides, and polyacrylamides, high molecular weight polyethers; copolymers of ethylene oxide and propylene oxide; fluoropolymers, such as polytetrafluoroethylene, polyvinylidene fluoride, and fluoro-olefin copolymers; acrylic polymers, such as sodium polyacrylate, poly(lower alkyl acrylates), poly(lower alkyl methacrylates) and copolymers of lower alkyl acrylates and methacrylates; and fatty acids and waxes, such as stearic and other soapy fatty acids, vegetable wax, microwaxes (purified paraffins), etc.

The resulting powder may be compacted to form a pellet using any conventional powder press device. For example, a press mold may be employed that is a single station compaction press containing a die and one or multiple punches. Alternatively, anvil-type compaction press molds may be used that use only a die and single lower punch. Single station compaction press molds are available in several basic types, such as cam, toggle/knuckle and eccentric/crank presses with varying capabilities, such as single action, double action, floating die, movable platen, opposed ram, screw, impact, hot pressing, coining or sizing. The powder may be compacted around an anode lead, which may be in the form of a wire, sheet, etc. The lead may extend in a longitudinal direction from the anode body and may be formed from any electrically conductive material, such as tantalum, niobium, aluminum, hafnium, titanium, etc., as well as electrically conductive oxides and/or nitrides of thereof. Connection of the lead may also be accomplished using other known techniques, such as by welding the lead to the body or embedding it within the anode body during formation (e.g., prior to compaction and/or sintering).

Any binder may be removed after pressing by heating the pellet under vacuum at a certain temperature (e.g., from about 150° C. to about 500° C.) for several minutes. Alternatively, the binder may also be removed by contacting the pellet with an aqueous solution, such as described in U.S. Pat. No. 6,197,252 to Bishop, et al. Thereafter, the pellet is sintered to form a porous, integral mass. The pellet is typically sintered at a temperature of from about 700° C. to about 1800° C., in some embodiments from about 800° C. to about 1700° C., and in some embodiments, from about 900° C. to about 1400° C., for a time of from about 5 minutes to about 100 minutes, and in some embodiments, from about 8 minutes to about 15 minutes. This may occur in one or more steps. If desired, sintering may occur in an atmosphere that limits the transfer of oxygen atoms to the anode. For example, sintering may occur in a reducing atmosphere, such as in a vacuum, inert gas, hydrogen, etc. The reducing atmosphere may be at a pressure of from about 10 Torr to about 2000 Torr, in some embodiments from about 100 Torr to about 1000 Torr, and in some embodiments, from about 100 Torr to about 930 Torr. Mixtures of hydrogen and other gases (e.g., argon or nitrogen) may also be employed.

### B. Dielectric

The anode body may also be coated with a dielectric. The dielectric may be formed by anodically oxidizing (“anodizing”) the anode body so that a dielectric layer is formed over and/or within the anode body. For example, a tantalum (Ta) anode body may be anodized to tantalum pentoxide (Ta₂O₅). Typically, anodization is performed by initially applying a solution to the anode body, such as by dipping anode body into the electrolyte. A solvent is generally employed, such as water (e.g., deionized water). To enhance ionic conductivity, a compound may be employed that is capable of dissociating in the solvent to form ions. Examples of such compounds include, for instance, acids, such as described below with respect to the electrolyte. For example, an acid (e.g., phosphoric acid) may constitute from about 0.01 wt. % to about 5 wt. %, in some embodiments from about 0.05 wt. % to about 0.8 wt. %, and in some embodiments, from about 0.1 wt. % to about 0.5 wt. % of the anodizing solution. If desired, blends of acids may also be employed.

A current is passed through the anodizing solution to form the dielectric layer. The value of the formation voltage manages the thickness of the dielectric layer. For example, the power supply may be initially set up at a galvanostatic mode until the required voltage is reached. Thereafter, the power supply may be switched to a potentiostatic mode to ensure that the desired dielectric thickness is formed over the entire surface of the anode body. Of course, other known methods may also be employed, such as pulse or step potentiostatic methods. The voltage at which anodic oxidation occurs typically ranges from about 4 to about 250 V, and in some embodiments, from about 5 to about 200 V, and in some embodiments, from about 10 to about 150 V. During oxidation, the anodizing solution can be kept at an elevated temperature, such as about 30° C. or more, in some embodiments from about 40° C. to about 200° C., and in some embodiments, from about 50° C. to about 100° C. Anodic oxidation can also be done at ambient temperature or lower. The resulting dielectric layer may be formed on a surface of the anode body and within its pores.

Although not required, in certain embodiments, the dielectric layer may possess a differential thickness throughout the anode body in that it possesses a first portion that overlies an external surface of the anode body and a second portion that overlies an interior surface of the anode body. In such embodiments, the first portion is selectively formed so that its thickness is greater than that of the second portion. It should be understood, however, that the thickness of the dielectric layer need not be uniform within a particular region. Certain portions of the dielectric layer adjacent to the external surface may, for example, actually be thinner than certain portions of the layer at the interior surface, and vice versa. Nevertheless, the dielectric layer may be formed such that at least a portion of the layer at the external surface has a greater thickness than at least a portion at the interior surface. Although the exact difference in these thicknesses may vary depending on the particular application, the ratio of the thickness of the first portion to the thickness of the second portion is typically from about 1.2 to about 40, in some embodiments from about 1.5 to about 25, and in some embodiments, from about 2 to about 20.

### C. Pre-Coat

Although by no means required, a pre-coat may optionally overlie the dielectric. The material used in the pre-coat may vary, such as polymers (e.g., polyarylenes, polyorganosiloxanes, etc.), organometallic compounds, etc. Suitable organometallic compounds may, for instance, have the following general formula:

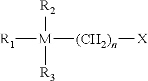

wherein,
M is an organometallic atom, such as silicon, titanium, and so forth;
R₁, R₂, and R₃ are independently an alkyl (e.g., methyl, ethyl, propyl, etc.) or a hydroxyalkyl (e.g., hydroxymethyl, hydroxyethyl, hydroxypropyl, etc.), wherein at least one of R₁, R₂, and R₃ is a hydroxyalkyl;
n is an integer from 0 to 8, in some embodiments from 1 to 6, and in some embodiments, from 2 to 4 (e.g., 3); and
X is an organic or inorganic functional group, such as glycidyl, glycidyloxy, mercapto, amino, vinyl, etc.

In certain embodiments, R₁, R₂, and R₃ may a hydroxyalkyl (e.g., OCH₃). In other embodiments, however, R₁ may be an alkyl (e.g., CH₃) and R₂ and R₃ may a hydroxyalkyl (e.g., OCH₃).

Further, in certain embodiments, M may be silicon so that the organometallic compound is an organosilane compound, such as an alkoxysilane. Suitable alkoxysilanes may include, for instance, 3-aminopropyltrimethoxysilane, 3-aminopropyltriethoxysilane, 3-aminopropylmethyldimethoxysilane, 3-aminopropylmethyldiethoxysilane, 3-(2-aminoethyl) aminopropyltrimethoxysilane, 3-mercaptopropyltrimethoxysilane, 3-mercaptopropyltriethoxysilane, 3-mercaptopropylmethyldimethoxysilane, 3-mercaptopropylmethyldiethoxysilane, glycidoxymethyltrimethoxysilane, glycidoxymethyltriethoxysilane, glycidoxymethyl-tripropoxysilane, glycidoxymethyltributoxysilane, β-glycidoxyethyltrimethoxysilane, β-glycidoxyethyltriethoxysilane, β-glycidoxyethyl-tripropoxysilane, β-glycidoxyethyl-tributoxysilane, β-glycidoxyethyltrimethoxysilane, α-glycidoxyethyltriethoxysilane, α-glycidoxyethyltripropoxysilane, α-glycidoxyethyltributoxysilane, γ-glycidoxypropyl-trimethoxysilane, γ-glycidoxypropyltriethoxysilane, γ-glycidoxypropyl-tripropoxysilane, γ-glycidoxypropyltributoxysilane, β-glycidoxypropyltrimethoxysilane, α-glycidoxypropyl-triethoxysilane, β-glycidoxypropyltripropoxysilane, α-glycidoxypropyltributoxysilane, α-glycidoxypropyltrimethoxysilane, α-glycidoxypropyltriethoxysilane, α-glycidoxypropyl-tripropoxysilane, α-glycidoxypropyltributoxysilane, γ-glycidoxybutyltrimethoxysilane, δ-glycidoxybutyltriethoxysilane, δ-glycidoxybutyltripropoxysilane, δ-glycidoxybutyl-tributoxysilane, δ-glycidoxybutyltrimethoxysilane, γ-glycidoxybutyltriethoxysilane, γ-glycidoxybutyltripropoxysilane, γ-propoxybutyltributoxysilane, δ-glycidoxybutyltrimethoxysilane, δ-glycidoxybutyltriethoxysilane, δ-glycidoxybutyltripropoxysilane, α-glycidoxybutyltrimethoxysilane, α-glycidoxybutyltriethoxysilane, α-glycidoxybutyltripropoxysilane, α-glycidoxybutyltributoxysilane, (3,4-epoxycyclohexyl)-methyl-trimethoxysilane, (3,4-epoxycyclohexyl) methyl-triethoxysilane, (3,4-epoxycyclohexyl) methyltripropoxysilane, (3,4-epoxycyclohexyl)-methyl-tributoxysilane, (3,4-epoxycyclohexyl) ethyl-trimethoxysilane, (3,4-epoxycyclohexyl) ethyl-triethoxysilane, (3,4-epoxycyclohexyl) ethyltripropoxysilane, (3,4-epoxycyclohexyl) ethyltributoxysilane, (3,4-epoxycyclohexyl) propyltrimethoxysilane, (3,4-epoxycyclohexyl) propyltriethoxysilane, (3,4-epoxycyclohexyl) propyl-tripropoxysilane, (3,4-epoxycyclohexyl) propyltributoxysilane, (3,4-epoxycyclohexyl) butyltrimethoxysilane, (3,4-epoxycyclohexy) butyltriethoxysilane, (3,4-epoxycyclohexyl) butyltripropoxysilane, (3,4-epoxycyclohexyl) butyltributoxysilane, and so forth.

The particular manner in which the pre-coat is applied may vary as desired. In one particular embodiment, a precursor compound (e.g., organometallic compound) is dissolved in an organic solvent and applied to the part as a solution, such as by screen-printing, dipping, electrophoretic coating, spraying, etc. The organic solvent may vary, but is typically an alcohol, such as methanol, ethanol, etc. Precursor compound(s) may constitute from about 0.1 wt. % to about 10 wt. %, in some embodiments from about 0.2 wt. % to about 8 wt. %, and in some embodiments, from about 0.5 wt. % to about 5 wt. % of the solution. Solvent(s) may likewise constitute from about 90 wt. % to about 99.9 wt. %, in some embodiments from about 92 wt. % to about 99.8 wt. %, and in some embodiments, from about 95 wt. % to about 99.5 wt. % of the solution. Once applied, the part may then be dried to remove the solvent therefrom and form the pre-coat containing the precursor compound.

### D. Solid Electrolyte

The solid electrolyte generally overlies the dielectric and porous anode body and may be disposed on a surface and/or within the pores of the body. The solid electrolyte generally contains a conductive material as is known in the art, such as conductive inorganic oxides (e.g., manganese dioxide), conductive polymers, etc. In certain embodiments, for example, a conductive polymer may be employed, such as polypyrroles, polythiophenes, polyanilines, etc., polyacetylenes, poly-p-phenylenes, polyphenolates, etc.), and so forth. Thiophene polymers are particularly suitable for use in the solid electrolyte. In certain embodiments, for instance, a thiophene polymer may be employed that has repeating units of the following formula (I):

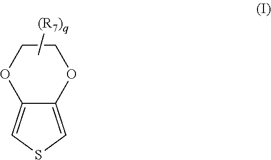

wherein,
R7 is a linear or branched, C₁ to C₁₈ alkyl radical (e.g., methyl, ethyl, n-or iso-propyl, n-, iso-, sec-or tert-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl, n-hexyl, n-heptyl, n-octyl, 2-ethylhexyl, n-nonyl, n-decyl, n-undecyl, n-dodecyl, n-tridecyl, n-tetradecyl, n-hexadecyl, n-octadecyl, etc.); C₅ to C₁₂ cycloalkyl radical (e.g., cyclopentyl, cyclohexyl, cycloheptyl, cyclooctyl, cyclononyl, cyclodecyl, etc.); C₆ to C₁₄ aryl radical (e.g., phenyl, naphthyl, etc.); C₇ to C₁₈ aralkyl radical (e.g., benzyl, o-, m-, p-tolyl, 2,3-, 2,4-, 2,5-, 2-6, 3-4-, 3,5-xylyl, mesityl, etc.); and
q is an integer from 0 to 8, in some embodiments, from 0 to 2, and in one embodiment, 0.

One commercially suitable example of 3,4-ethylenedioxthiophene is available from Heraeus under the designation Clevios™. Other suitable monomers are also described in U.S. Pat. No. 5,111,327 to Blohm, et al. and U.S. Pat. No. 6,635,729 to Groenendaal, et al. Derivatives of these monomers may also be employed that are, for example, dimers or trimers of the above monomers. Higher molecular derivatives, i.e., tetramers, pentamers, etc. of the monomers are suitable for use in the present invention. The derivatives may be made up of identical or different monomer units and used in pure form and in a mixture with one another and/or with the monomers. Oxidized or reduced forms of these precursors may also be employed.

To form the polymer, the precursor monomer may be polymerized in the presence of an oxidative catalyst (e.g., chemically polymerized). The oxidative catalyst typically includes a transition metal cation, such as iron(III), copper(II), chromium(VI), cerium(IV), manganese(IV), manganese(VII), or ruthenium(III) cations, and etc. A dopant may also be employed to provide excess charge to the conductive polymer and stabilize the conductivity of the polymer. The dopant typically includes an inorganic or organic anion, such as an ion of a sulfonic acid (e.g., p-toluene sulfonate). In certain embodiments, the oxidative catalyst has both a catalytic and doping functionality in that it includes a cation (e.g., transition metal) and an anion (e.g., sulfonic acid). For example, the oxidative catalyst may be a transition metal salt that includes iron(III) cations, such as iron(III) halides (e.g., FeCl₃) or iron(III) salts of other inorganic acids, such as Fe(ClO₄)₃ or Fe₂(SO₄)₃ and the iron(III) salts of organic acids and inorganic acids comprising organic radicals. Examples of iron(III) salts of inorganic acids with organic radicals include, for instance, iron(III) salts of sulfuric acid monoesters of C₁ to C₂₀ alkanols (e.g., iron(III) salt of lauryl sulfate). Likewise, examples of iron(III) salts of organic acids include, for instance, iron(III) salts of C₁ to C₂₀ alkane sulfonic acids (e.g., methane, ethane, propane, butane, or dodecane sulfonic acid); iron (III) salts of aliphatic perfluorosulfonic acids (e.g., trifluoromethane sulfonic acid, perfluorobutane sulfonic acid, or perfluorooctane sulfonic acid); iron(III) salts of aliphatic C₁ to C₂₀carboxylic acids (e.g., 2-ethylhexylcarboxylic acid); iron (III) salts of aliphatic perfluorocarboxylic acids (e.g., trifluoroacetic acid or perfluorooctane acid); iron(III) salts of aromatic sulfonic acids optionally substituted by C₁ to C₂₀ alkyl groups (e.g., benzene sulfonic acid, o-toluene sulfonic acid, p-toluene sulfonic acid, or dodecylbenzene sulfonic acid); iron (III) salts of cycloalkane sulfonic acids (e.g., camphor sulfonic acid); and so forth. Mixtures of these above-mentioned iron(III) salts may also be used. Iron (III)-p-toluene sulfonate, iron(III)-o-toluene sulfonate, and mixtures thereof, are particularly suitable. One commercially suitable example of iron(III)-p-toluene sulfonate is available from Heraeus under the designation Clevios™ C.

The conductive polymer may be formed “in situ” on the porous anode body and/or “pre-polymerized” into particles that are subsequently applied to the anode body. Pre-polymerized polymer particles may, for instance, contain an intrinsically conductive polymer that has a positive charge located on the main chain that is at least partially compensated by anions covalently bound to the polymer. Such polymers may, for example, have a relatively high specific conductivity, in the dry state, of about 1 Siemen per centimeter (“S/cm”) or more, in some embodiments about 10 S/cm or more, in some embodiments about 25 S/cm or more, in some embodiments about 40 S/cm or more, and in some embodiments, from about 50 to about 500 S/cm. One example of a suitable intrinsically conductive thiophene polymer may have repeating units of the following formula (II):

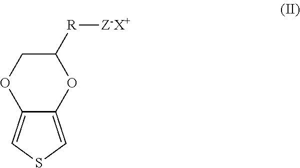

wherein,
R is (CH₂)a-O-(CH₂)b-L, where L is a bond or HC([CH₂]cH);
a is from 0 to 10, in some embodiments from 0 to 6, and in some embodiments, from 1 to 4 (e.g., 1);
b is from 1 to 18, in some embodiments from 1 to 10, and in some embodiments, from 2 to 6 (e.g., 2, 3, 4, or 5);
c is from 0 to 10, in some embodiments from 0 to 6, and in some embodiments, from 1 to 4 (e.g., 1);
Z is an anion, such as SO₃, C (O)O, BF₄, CF₃SO₃, SbF₆, N (SO₂CF₃)₂, C₄H₃O₄, ClO₄, etc.;
X is a cation, such as hydrogen, an alkali metal (e.g., lithium, sodium, rubidium, cesium or potassium), ammonium, etc.

In one particular embodiment, Z in formula (III) is a sulfonate ion such that the intrinsically conductive polymer contains repeating units of the following formula (III):

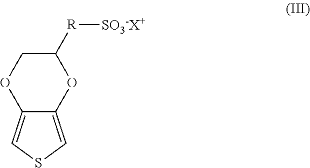

wherein, R and X are defined above. In formula (II) or (III), a is preferably 1 and b is preferably 3 or 4. Likewise, X is preferably sodium or potassium.

If desired, the polymer may be a copolymer that contains other types of repeating units. In such embodiments, the repeating units of formula (II) typically constitute about 50 mol. % or more, in some embodiments from about 75 mol. % to about 99 mol. %, and in some embodiments, from about 85 mol. % to about 95 mol. % of the total amount of repeating units in the copolymer. Of course, the polymer may also be a homopolymer to the extent that it contains 100 mol. % of the repeating units of formula (II). Specific examples of such homopolymers include poly (4-(2,3-dihydrothieno-[3,4-b][1,4]dioxin-2-ylmethoxy)-1-butane-sulphonic acid, salt) and poly (4-(2,3-dihydrothieno-[3,4-b][1,4]dioxin-2-ylmethoxy)-I-propanesulphonic acid, salt).

In another embodiment, the intrinsically conductive polymer has repeating thiophene units of the following general formula (IV):

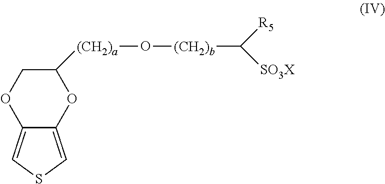

wherein,
a and b are as defined above;
R₅ is an optionally substituted C₁-C₆ linear or branched alkyl group (e.g., methyl) or a halogen atom (e.g., fluorine);
X is a hydrogen atom, an alkali metal (e.g., Li, Na, or K), NH(R₁)₃, or HNC₅H₅, wherein R₁ is each independently a hydrogen atom or an optionally substituted C₁-C₆ alkyl group.

Specific examples of thiophene compounds used to form such repeating are described in U.S. Pat. No. 9,718,905 and may include, for instance, sodium 3-[(2,3-dihydrothieno [3,4-b][1,4] dioxin-2-yl) methoxy]-1-methyl-1-propanesulfonate, sodium 3-[(2,3-dihydrothieno[3,4-b]-[1,4]dioxin-2-yl) methoxy]-1-ethyl-1-propanesulfonate, sodium 3-[(2,3-dihydrothieno[3,4-b]-[1,4]dioxin-2-yl) methoxy]-1-propyl-1-propane-sulfonate, sodium 3-[(2,3-dihydrothieno[3,4-b]-[1,4] dioxin-2-yl)methoxy]-1-butyl-1-propanesulfonate, sodium 3-[(2,3-dihydrothieno [3,4-b]-[1,4]dioxin-2-yl)methoxy]-1-pentyl-1-propane-sulfonate, sodium 3-[(2,3-dihydrothieno [3,4-b]-[1,4] dioxin-2-yl) methoxy]-1-hexyl-1-propanesulfonate, sodium 3-[(2,3-dihydrothieno [3,4-b]-[1,4] dioxin-2-yl) methoxy]-1-isopropyl-1-propanesulfonate, sodium 3-[(2,3-dihydrothieno [3,4-b]-[1,4] dioxin-2-yl) methoxy]-1-isobutyl-1-propanesulfonate, sodium 3-[(2,3-dihydrothieno [3,4-b]-[1,4]dioxin-2-yl) methoxy]-1-isopentyl-1-propanesulfonate, sodium 3-[(2,3-dihydrothieno[3,4-b]-[1,4]dioxin-2-yl) methoxy]-1-fluoro-1-propanesulfonate, potassium 3-[(2,3-dihydrothieno [3,4-b]-[1,4] dioxin-2-yl) methoxy]-1-methyl-1-propanesulfonate, 3-[(2,3-dihydrothieno [3,4-b]-[1,4]dioxin-2-yl) methoxy]-1-methyl-1-propanesulfonic acid, ammonium 3-[(2,3-dihydrothieno[3,4-b]-[1,4]dioxin-2-yl) methoxy]-1-methyl-1-propane-sulfonate, triethylammonium 3-[(2,3-dihydrothieno[3,4-b]-[1,4]dioxin-2-yl) methoxy]-1-methyl-1-propanesulfonate, etc., as well as combination thereof. Each of the above exemplified thiophene monomers may be prepared from thieno[3,4-b]-1,4-dioxin-2-methanol and a branched sulfone compound in accordance with a known method (e.g., Journal of Electroanalytical Chemistry, 443, 217 to 226 (1998)).

“Extrinsically” conductive polymers may also be employed in the conductive polymer particles, which generally require the presence of a separate counterion that is not covalently bound to the polymer. One example of such an extrinsically conductive polymer is poly (3,4-ethylenedioxythiophene). The counterion may be a monomeric or polymeric anion that counteracts the charge of the conductive polymer. Polymeric anions can, for example, be anions derived from polymeric carboxylic acids (e.g., poly (meth) acrylic acids, such as poly-2-sulfoethyl (meth) acrylate or poly-3-propylsulfo (meth) acrylate; polymaleic acids; etc.); polymeric sulfonic acids (e.g., polystyrene sulfonic acids (“PSS”), polyvinyl sulfonic acids, etc.); and so forth, as well as salts thereof, such as an alkali metal, alkaline earth metal, transition metal, or ammonium salt thereof. Likewise, suitable monomeric anions may be derived from C1 to C20 alkane sulfonic acids (e.g., dodecane sulfonic acid); aliphatic fluorosulfonic acids (e.g., trifluoromethane sulfonic acid, perfluorobutane sulfonic acid, perfluorooctane sulfonic acid, trifluoromethanesulfonimide, etc.); aliphatic C1 to C20 carboxylic acids (e.g., 2-ethyl-hexylcarboxylic acid); aliphatic fluorocarboxylic acids (e.g., trifluoroacetic acid or perfluorooctanoic acid); aromatic sulfonic acids optionally substituted by C1 to C20 alkyl groups (e.g., benzene sulfonic acid, o-toluene sulfonic acid, p-toluene sulfonic acid, or dodecylbenzene sulfonic acid); cycloalkane sulfonic acids (e.g., camphor sulfonic acid); boronic compounds (e.g., tetrafluoroboric acid); phosphoric compounds (e.g., hexafluorophosphoric acid); and so forth, as well as salts thereof, such as an alkali metal, alkaline earth metal, transition metal, or ammonium salt thereof. Particularly suitable counteranions are polymeric anions, such as those derived from a polymeric carboxylic or sulfonic acid (e.g., polystyrene sulfonic acid (“PSS”)). The molecular weight of such compounds typically ranges from about 1,000 to about 2,000,000, and in some embodiments, from about 2,000 to about 500,000.

Whether intrinsically or extrinsically conductive, pre-polymerized conductive polymer particles may be applied to the anode body in a variety of forms, such as a solution, dispersion, etc. Intrinsically conductive polymers, for example, are typically applied in the form of a solution and extrinsically conductive polymers are typically applied in the form of a dispersion.

When a solution is employed, the concentration of the polymer may vary depending on the desired viscosity of and the particular manner in which the layer is to be applied to the anode body. Typically, however, the polymer constitutes from about 0.1 to about 10 wt. %, in some embodiments from about 0.4 to about 5 wt. %, and in some embodiments, from about 0.5 to about 4 wt. % of the solution. Solvent(s) may likewise constitute from about 90 wt. % to about 99.9 wt. %, in some embodiments from about 95 wt. % to about 99.6 wt. %, and in some embodiments, from about 96 wt. % to about 99.5 wt. % of the solution. While other solvents may certainly be employed, it is generally desired that water is the primary solvent such that the solution is considered an “aqueous” solution. In most embodiments, for example, water constitutes at least about 50 wt. %, in some embodiments at least about 75 wt. %, and in some embodiments, from about 90 wt. % to 100 wt. % of the solvent(s) employed. When employed, a solution may be applied to the anode body using any known technique, such as dipping, casting (e.g., curtain coating, spin coating, etc.), printing (e.g., gravure printing, offset printing, screen printing, etc.), and so forth. The resulting conductive polymer layer may be dried and/or washed after it is applied to the anode body.

The conductive polymer particles typically have an average size (e.g., diameter) of from about 1 to about 100 nanometers, in some embodiments from about 2 to about 80 nanometers, and in some embodiments, from about 4 to about 50 nanometers. The diameter of the particles may be determined using known techniques, such as by ultracentrifuge, laser diffraction, etc. The shape of the particles may likewise vary. In one particular embodiment, for instance, the particles are spherical in shape. However, it should be understood that other shapes are also contemplated by the present invention, such as plates, rods, discs, bars, tubes, irregular shapes, etc. The concentration of the particles in the dispersion may vary depending on the desired viscosity of the dispersion and the particular manner in which the dispersion is to be applied to the capacitor element. Typically, however, the particles constitute from about 0.1 to about 10 wt. %, in some embodiments from about 0.4 to about 5 wt. %, and in some embodiments, from about 0.5 to about 4 wt. % of the dispersion. The dispersion may also contain one or more binders, dispersion agents, fillers, surfactants, adhesives, etc. as is well known in the art. The dispersion may be applied using a variety of known techniques, such as by spin coating, impregnation, pouring, dropwise application, injection, spraying, doctor blading, brushing, printing (e.g., inkjet, screen, or pad printing), or dipping. The viscosity of the dispersion is typically from about 0.1 to about 100,000 mPas (measured at a shear rate of 100 s-1), in some embodiments from about 1 to about 10,000 mPas, in some embodiments from about 10 to about 1,500 mPas, and in some embodiments, from about 100 to about 1000 mPas.

If desired, the solid electrolyte may be formed from multiple layers, such as inner and/or outer layers. The term “inner” in this context refers to one or more layers that overly the dielectric, whether directly or via another layer (e.g., pre-coat layer). The inner layer(s), for example, may contain an intrinsically conductive polymer and/or extrinsically conductive polymer as described above. In other embodiments, the inner layer(s) may contain a conductive polymer that is polymerized “in situ” using a polymerization process. In such an “in situ” process, as is well known in the art, an oxidative catalyst and precursor monomer may be applied either sequentially or together to initiate the polymerization reaction. One or multiple inner layers may be employed. For example, the solid electrolyte typically contains from 2 to 30, in some embodiments from 4 to 20, and in some embodiments, from about 5 to 15 inner layers (e.g., 10 layers). The solid electrolyte may contain only “inner layers” so that it is essentially formed from the same material. Nevertheless, in other embodiments, the solid electrolyte may also contain one or more optional “outer” conductive polymer layers that are formed from a different material than the inner layer(s) and overly the inner layer(s). For example, the inner layer(s) may be formed from an in-situ polymerized conductive polymer and/or solution of an intrinsically conductive polymer, while the outer layer(s) be formed from a dispersion of an extrinsically conductive polymer. In one particular embodiment, the outer layer(s) are formed primarily from such extrinsically conductive polymers in that they constitute about 50 wt. % or more, in some embodiments about 70 wt. % or more, and in some embodiments, about 90 wt. % or more (e.g., 100 wt. %) of a respective outer layer. One or multiple outer layers may be employed. For example, the solid electrolyte may contain from 2 to 30, in some embodiments from 4 to 20, and in some embodiments, from about 5 to 15 outer layers. The total thickness of the solid electrolyte can vary, but is typically from about 0.1 to about 50 μm, in some embodiments from about 0.5 to about 30 μm, and in some embodiments, from about 1 to about 20 μm.

### E. External Polymer Coating

An external polymer coating may also overly the solid electrolyte. The external polymer coating may contain one or more layers formed from pre-polymerized conductive polymer particles such as described above (e.g., dispersion of extrinsically conductive polymer particles). The external coating may be able to further penetrate into the edge region of the capacitor body to increase the adhesion to the dielectric and result in a more mechanically robust part, which may reduce equivalent series resistance and leakage current. Because it is generally intended to improve the degree of edge coverage rather to impregnate the interior of the anode body, the particles used in the external coating typically have a larger size than those employed in the solid electrolyte. For example, the ratio of the average size of the particles employed in the external polymer coating to the average size of the particles employed in any dispersion of the solid electrolyte is typically from about 1.5 to about 30, in some embodiments from about 2 to about 20, and in some embodiments, from about 5 to about 15. For example, the particles employed in the dispersion of the external coating may have an average size of from about 80 to about 500 nanometers, in some embodiments from about 90 to about 250 nanometers, and in some embodiments, from about 100 to about 200 nanometers.

If desired, a crosslinking agent may also be employed in the external polymer coating to enhance the degree of adhesion to the solid electrolyte. Typically, the crosslinking agent is applied prior to application of the dispersion used in the external coating. Suitable crosslinking agents are described, for instance, in U.S. Patent Publication No. 2007/0064376 to Merker, et al. and include, for instance, amines (e.g., diamines, triamines, oligomer amines, polyamines, etc.); polyvalent metal cations, such as salts or compounds of Mg, Al, Ca, Fe, Cr, Mn, Ba, Ti, Co, Ni, Cu, Ru, Ce or Zn, phosphonium compounds, sulfonium compounds, etc. Particularly suitable examples include, for instance, 1,4-diaminocyclohexane, 1,4-bis (amino-methyl) cyclohexane, ethylenediamine, 1,6-hexanediamine, 1,7-heptanediamine, 1,8-octanediamine, 1,9-nonanediamine, 1,10-decanediamine, 1,12-dodecanediamine, N,N-dimethylethylenediamine, N,N,N′,N′-tetramethylethylenediamine, N,N,N′,N′-tetramethyl-1,4-butanediamine, etc., as well as mixtures thereof.

The crosslinking agent is typically applied from a solution or dispersion whose pH is from 1 to 10, in some embodiments from 2 to 7, in some embodiments, from 3 to 6, as determined at 25° C. Acidic compounds may be employed to help achieve the desired pH level. Examples of solvents or dispersants for the crosslinking agent include water or organic solvents, such as alcohols, ketones, carboxylic esters, etc. The crosslinking agent may be applied to the capacitor body by any known process, such as spin-coating, impregnation, casting, dropwise application, spray application, vapor deposition, sputtering, sublimation, knife-coating, painting or printing, for example inkjet, screen or pad printing. Once applied, the crosslinking agent may be dried prior to application of the polymer dispersion. This process may then be repeated until the desired thickness is achieved. For example, the total thickness of the entire external polymer coating, including the crosslinking agent and dispersion layers, may range from about 1 to about 50 μm, in some embodiments from about 2 to about 40 μm, and in some embodiments, from about 5 to about 20 μm.

### F. Cathode Coating

If desired, the capacitor element may also employ a cathode coating that overlies the solid electrolyte and other optional layers (e.g., external polymer coating). The cathode coating may contain a metal particle layer includes a plurality of conductive metal particles dispersed within a polymer matrix. The particles typically constitute from about 50 wt. % to about 99 wt. %, in some embodiments from about 60 wt. % to about 98 wt. %, and in some embodiments, from about 70 wt. % to about 95 wt. % of the layer, while the polymer matrix typically constitutes from about 1 wt. % to about 50 wt. %, in some embodiments from about 2 wt. % to about 40 wt. %, and in some embodiments, from about 5 wt. % to about 30 wt. % of the layer. The conductive metal particles may be formed from a variety of different metals, such as copper, nickel, silver, nickel, zinc, tin, lead, copper, aluminum, molybdenum, titanium, iron, zirconium, magnesium, etc., as well as alloys thereof. Silver is a particularly suitable conductive metal for use in the layer. The metal particles often have a relatively small size, such as an average size of from about 0.01 to about 50 micrometers, in some embodiments from about 0.1 to about 40 micrometers, and in some embodiments, from about 1 to about 30 micrometers. Typically, only one metal particle layer is employed, although it should be understood that multiple layers may be employed if so desired. The total thickness of such layer(s) is typically within the range of from about 1 μm to about 500 μm, in some embodiments from about 5 μm to about 200 μm, and in some embodiments, from about 10 μm to about 100 μm.

### G. Other Components

If desired, the capacitor may also contain other layers as is known in the art. In certain embodiments, for instance, a carbon layer (e.g., graphite) may be positioned between the solid electrolyte and the silver layer that can help further limit contact of the silver layer with the solid electrolyte.

### II. Terminations

Once the desired layers are formed, the capacitor may be provided with terminations as indicated above. More particularly, the capacitor may contain an anode termination to which an anode lead of the capacitor element is electrically connected and a cathode termination to which the solid electrolyte of the capacitor element is electrically connected. Any conductive material may be employed to form the terminations, such as a conductive metal (e.g., copper, nickel, silver, nickel, nickel, zinc, tin, palladium, lead, copper, aluminum, molybdenum, titanium, iron, zirconium, magnesium, and alloys thereof). Particularly suitable conductive metals include, for instance, copper, copper alloys (e.g., copper-zirconium, copper-magnesium, copper-zinc, or copper-iron), nickel, and nickel alloys (e.g., nickel-iron). The thickness of the terminations is generally selected to minimize the thickness of the capacitor. For instance, the thickness of the terminations may range from about 0.05 to about 1 millimeter, in some embodiments from about 0.05 to about 0.5 millimeters, and from about 0.07 to about 0.2 millimeters. One exemplary conductive material is a copper-iron alloy metal plate available from Wieland (Germany). If desired, the surface of the terminations may be electroplated with nickel, silver, gold, tin, etc. as is known in the art to ensure that the final part is mountable to the circuit board. In one particular embodiment, both surfaces of the terminations are plated with nickel and silver flashes, respectively, while the mounting surface is also plated with a tin solder layer.

The terminations may be connected to the capacitor element using any technique known in the art. In one embodiment, for example, a lead frame may be provided that defines the cathode termination and anode termination. To attach the capacitor element to the lead frame, a conductive adhesive may initially be applied to a surface of the cathode termination. The conductive adhesive may include, for instance, conductive metal particles contained with a resin composition. The metal particles may be silver, copper, gold, platinum, nickel, zinc, bismuth, etc. The resin composition may include a thermoset resin (e.g., epoxy resin), curing agent (e.g., acid anhydride), and coupling agent (e.g., silane coupling agents). Suitable conductive adhesives may be described in U.S. Patent Application Publication No. 2006/0038304 to Osako, et al. Any of a variety of techniques may be used to apply the conductive adhesive to the cathode termination. Printing techniques, for instance, may be employed due to their practical and cost-saving benefits. The anode lead may also be electrically connected to the anode termination using any technique known in the art, such as mechanical welding, laser welding, conductive adhesives, etc. Upon electrically connecting the anode lead to the anode termination, the conductive adhesive may then be cured to ensure that the electrolytic capacitor is adequately adhered to the cathode termination.

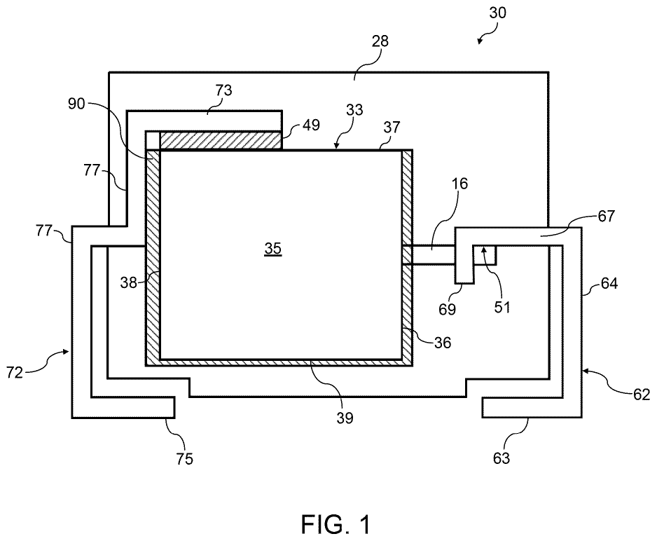

Referring to FIGS. 1-4, for example, a capacitor 30 is shown as including an anode termination 62 and a cathode termination 72 in electrical connection with a capacitor element 33 having an upper surface 37, lower surface 39, front surface 36, rear surface 38, first side surface 35, and opposing side surface (not shown). The cathode termination 72 may be provided in electrical contact with any surface of the capacitor element, such as via a conductive adhesive 49. However, it should be understood that the conductive adhesive 49 is not required. Referring now to FIGS. 1-3, for example, the cathode termination 72 contains a first component 73 that is generally parallel and adjacent to the upper surface 37 and a second component 75 that is generally parallel and adjacent to the lower surface 39. The first component 73 is also in electrical contact with the upper surface 37. For instance, in some embodiments, the first component 73 is in electrical contact with the upper surface 37 via an optional conductive adhesive 49. The cathode termination 72 may also contain a third component 77 generally extends in a direction perpendicular to the first component 73 and second component 75. If desired, the third component 77 may also be provided in electrical contact with the rear surface 38 of the capacitor element 33. The anode termination 62 likewise contains a first component 63 that is generally parallel to the lower surface 39 of the capacitor element 33 and a second component 67 that is generally parallel to the anode lead 16. Further, the anode termination 62 may include a third component 64 that is generally perpendicular to the first component 63 and a fourth component 69 that is generally perpendicular to the second component 67 and located adjacent to the anode lead 16. In the illustrated embodiment, the second component 67 and fourth component 69 define a region 51 for connection to the anode lead 16. Although not depicted in FIGS. 1-3, the region 51 may possess a “U-shape” to further enhance surface contact and mechanical stability of the lead 16.

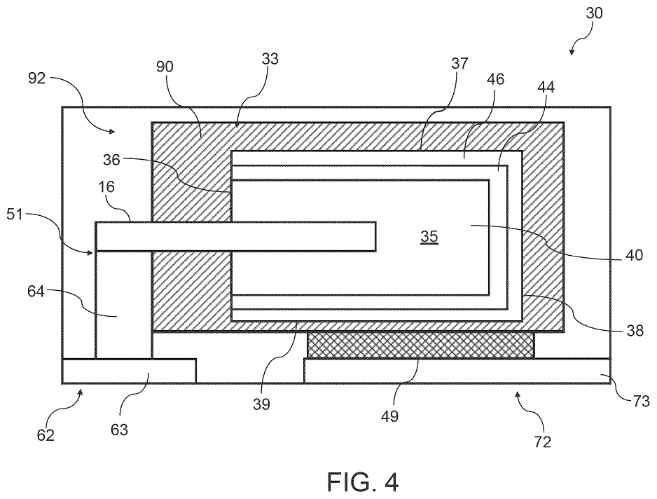

Referring now to FIG. 4, in another embodiment the terminations may be primarily located on the bottom of the capacitor-also known as “facedown” or “undertab” terminations. As demonstrated by FIG. 4, one embodiment of a capacitor 30 is shown that contains a capacitor element 33 having a generally rectangular shape and a front surface 36, rear surface 38, top surface 37, bottom surface 39, first side surface 35, and second side surface (not shown). In the illustrated embodiment, an anode lead 16 is embedded within an anode body 40 and extends from the front surface 36 of the capacitor element 33 in a longitudinal direction. The capacitor element 33 contains a dielectric 44 that overlies the anode body 40 and a solid electrolyte 46 that overlies that dielectric 44. As shown, the solid electrolyte 46 is typically present at each surface of the capacitor 30 except for the front surface 36. Of course, it should be understood that such layers may be applied to any surface of the capacitor, and need not be applied in the manner illustrated.

The capacitor 30 is shown as including an anode termination 62 and a cathode termination 72 in electrical connection with the capacitor element 33. Although it may be in electrical contact with any of the surfaces of the capacitor element 33, the cathode termination 72 in the illustrated embodiment is in electrical contact with the lower surface 39. In some embodiments, although not required, the cathode termination 72 may be in contact with the lower surface 39 via a conductive adhesive 49. More specifically, the cathode termination 72 contains a first component 73 that is in electrical contact and generally parallel with the lower surface 39 of the capacitor element 33. The anode termination 62 likewise contains a first component 63 positioned substantially perpendicular to a second component 64. The first component 63 is in electrical contact and generally parallel with the lower surface 39 of the capacitor element 33. The second component 64 contains a region 51 that carries an anode lead 16.

The terminations may be connected to the capacitor element using any technique known in the art. In one embodiment, for example, a lead frame may be provided that defines the cathode termination 72 and anode termination 62. Although by no means required, a conductive adhesive 49 may be applied to a surface of the cathode termination 72 to help attach the capacitor element 33 to the lead frame. In some embodiments, the capacitor element 33 is positioned on the cathode termination 72 so that its upper surface 37 contacts the adhesive 49 and the anode lead 16 contacts the region 51. The anode lead 16 is then electrically connected to the region 51 using any technique known in the art, such as mechanical welding, laser welding, conductive adhesives, etc. For example, the anode lead 16 may be welded to the anode termination 62 using a laser. Lasers generally contain resonators that include a laser medium capable of releasing photons by stimulated emission and an energy source that excites the elements of the laser medium. One type of suitable laser is one in which the laser medium consists of an aluminum and yttrium garnet (YAG), doped with neodymium (Nd). The excited particles are neodymium ions Nd³⁺. The energy source may provide continuous energy to the laser medium to emit a continuous laser beam or energy discharges to emit a pulsed laser beam. Upon electrically connecting the anode lead 16 to the anode termination 62, the conductive adhesive may then be cured. For example, a heat press may be used to apply heat and pressure to ensure that the electrolytic capacitor element 33 is adequately adhered to the cathode termination 72 by the adhesive 49.

### III. Barrier Coating

As indicated above, a barrier coating is disposed adjacent to the anode termination and/or cathode termination. In some embodiments, the barrier coating may be in contact with the casing material. One or multiple coatings may be employed. In one embodiment, for instance, a barrier coating may be employed that covers at least a portion of the anode termination. In some embodiments, the coating may also contact at least a portion of a surface of the capacitor element, such as a front surface, rear surface, lower surface, upper surface, first side surface, and/or opposing side surface of the capacitor element. Likewise, the coating may also contact at least a portion of the anode lead. In another embodiment, a barrier coating may be employed that covers at least a portion of the cathode termination. In certain embodiments, a barrier coating may not be in contact with at least a part of the anode termination and/or the cathode termination. In other embodiments, the entire capacitor element is covered by the barrier coating.

Referring now to FIG. 1, for example, the capacitor 30 is shown with a barrier coating 90 that is disposed adjacent to at least a portion of the cathode termination 72. As demonstrated, the barrier coating 90 is disposed adjacent to at least a portion of the third component 77. In some embodiments, the barrier coating 90 directly contacts at least a portion of the third component 77. The barrier coating 90 may also be disposed adjacent to the first component 73 of the cathode termination 72. The barrier coating 90 may contact at least a portion of the first component 73 of the cathode termination 72 or may contact an optional adhesive 49 that is disposed on the first component 73 of the cathode termination 72.

Additionally, the barrier coating 90 may be disposed on the capacitor element 33. For instance, the barrier coating 90 may contact at least a portion of the upper surface 37, lower surface 39, front surface 36, rear surface 38, first side surface 35, and/or opposing side surface (not shown) of the capacitor element. In other embodiments, the barrier coating 90 may coat the entire upper surface 37, lower surface 39, front surface 36, rear surface 38, first side surface 35, and/or opposing side surface (not shown). Additionally, the barrier coating 90 may coat the capacitor element 33 so that it may be disposed adjacent to at least a portion of the cathode termination 72 and anode lead 16.

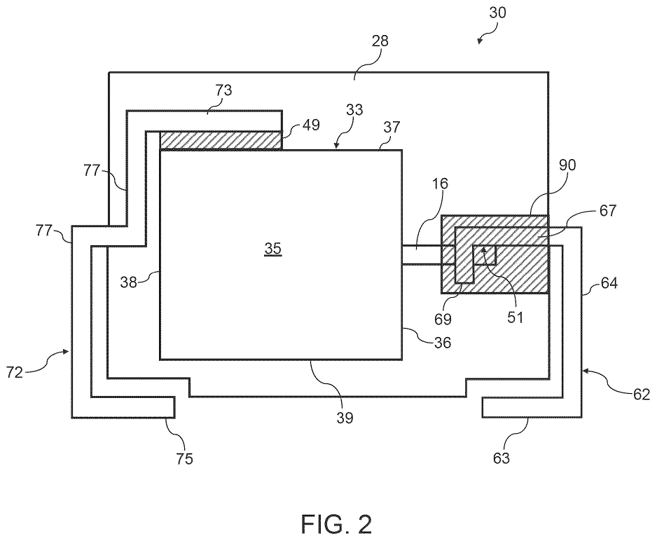

Referring again to FIG. 2, for example, the capacitor 30 is shown with a barrier coating 90 that is on the anode termination 62. More particularly, in the illustrated embodiment, the coating 90 is in contact with the second component 67 and the fourth component 69 of the anode termination 62 so that the region 51 is generally covered. The coating 90 is also in contact with at least a portion of the anode lead 16, particularly at those locations surrounding the region 51 at which the lead 16 is connected to the anode termination 62. However, it should be understood that in some embodiments the coating may have different configurations on the anode termination. For instance, in certain embodiments the barrier coating 90 contacts only the second component 67 of the anode termination 62.

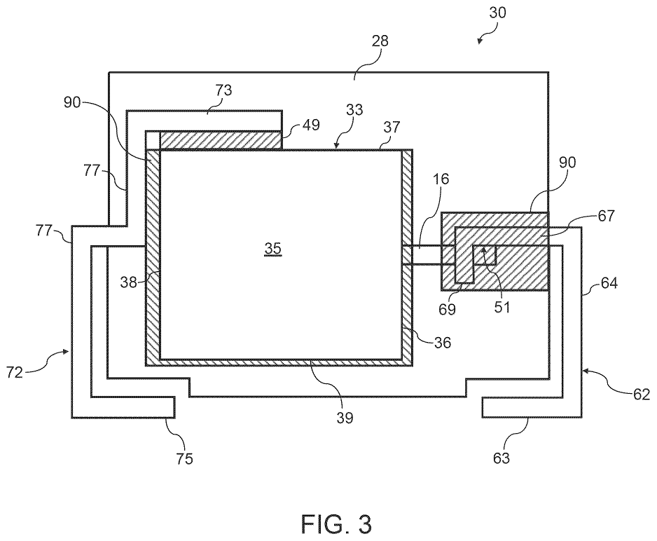

Referring now to FIG. 3, the barrier coating(s) 90 may be disposed adjacent to at least a part of the capacitor element 33, the cathode termination 72, and the anode termination 62, as detailed above. As demonstrated by FIG. 3, the barrier coating 90 may be disposed adjacent to the cathode termination 72, such that it may contact at least a portion of the first component 73 or the third component 77 of the cathode termination 72 directly, or it may contact an optional conductive adhesive 49 that is disposed on the cathode termination 72.

Referring now to FIG. 4, for instance, the barrier coating 90 may also coat the capacitor element 33 so that the barrier coating 90 may contact at least a portion of the upper surface 37, lower surface 39, front surface 36, rear surface 38, first side surface 35, and/or opposing side surface (not shown). As demonstrated by FIG. 4, the barrier coating 90 may also be disposed adjacent to at least a portion of the cathode termination 72 and/or anode termination 62. For instance, in some embodiments, the barrier coating 90 may contact at least a portion of the cathode termination 72 or the anode termination 62. In other embodiments, although not required, a conductive adhesive 49 may be disposed on the cathode termination 72. Thus, in certain embodiments, the barrier coating 90 may be disposed on the capacitor element 33 in a way that it is disposed adjacent to the cathode termination 72 and contacts at least a portion of the conductive adhesive 49.

Of course, it should be understood that the coating may also be provided in other configurations and disposed on any surface desired. Further, it should be understood that the use of the conductive adhesive 49 is not required, and thus, the barrier coating, when disposed adjacent to a surface, may contact either the surface directly or a conductive adhesive.

As indicated above, the resinous material employed in the barrier coating includes a hydrocarbon polymer in which at least one monomeric component is composed of carbon-carbon bonds and typically containing from 2 to 20 carbon atoms, in some embodiments, from 2 to 8 carbon atoms in the main chain. The hydrocarbon polymer may be a homopolymer or copolymer (e.g., block copolymer, graft copolymer, etc.) in which at least one monomeric component of the copolymer is composed of carbon-carbon bonds. The nature of the hydrocarbon-based monomeric component may vary. For example, the hydrocarbon-based monomeric component may be derived from an unsaturated hydrocarbon, such as an olefin that can be acyclic (aliphatic), cyclic (containing a partially saturated cycloalkyl ring having at least one carbon-carbon ring unsaturation), or aromatic (containing a single aromatic ring (e.g., phenyl) or multiple rings (e.g., fused, bridged, or spiro); linear and/or branched; and either unsubstituted or substituted with one or more functional groups. The unsaturated hydrocarbon may sometimes contain multiple carbon-carbon bonds that are unsaturated, such as a diene in which the hydrocarbon chain has two double bonds that may or may not be adjacent to each other. Examples of suitable aliphatic olefins may include, for instance, ethylene, propylene, butene, butadiene, pentene, hexene, heptene, octene, etc., as well as combinations thereof. Examples of suitable cyclic olefins may include, for instance, cyclopropylene, cyclobutylene, cyclopentylene, cyclohexylene, norbornene, tetrocyclododecene, etc., as well as combinations thereof. Examples of suitable aromatic olefins may likewise include, for instance, benzene (phenylene), naphthalene, anthracene, tetracene, etc., as well as combinations thereof.

If desired, one or more carbon atoms of the olefin monomeric component (aliphatic, cyclic and/or aromatic) may also be substituted with nitrogen, sulfur, or oxygen to form a hetero-olefin. Heterocyclic olefins may include, for instance, but is not limited to, oxane, dioxane, azetidine, piperidine, pyrrolidine, morpholine, hiomorpholine, imidazolidine, etc., as well as combinations thereof. The olefin monomeric component (including hetero-olefins) may also contain one or more substitution groups, such as alkyl (e.g., methyl, propyl, ethyl, butyl, heptyl, hexyl, etc.), substituted alkyl (e.g., methylpropyl), alkenyl, substituted alkenyl, alkynyl, substituted alkynyl, alkoxy, substituted alkoxy, acyl, acylamino, acyloxy, amino, substituted amino, quaternary amino, aminocarbonyl, imino, amidino, aminocarbonylamino, amidinocarbonylamino, aminothiocarbonyl, aminocarbonylamino, aminothiocarbonylamino, aminocarbonyloxy, aminosulfonyl, aminosulfonyloxy, aminosulfonylamino, aryl, substituted aryl, aryloxy, substituted aryloxy, arylthio, substituted arylthio, azido, carboxyl, carboxyl ester, (carboxyl ester)amino, (carboxyl ester)oxy, cyano, cycloalkyl, substituted cycloalkyl, cycloalkyloxy, substituted cycloalkyloxy, cycloalkylthio, substituted cycloalkylthio, guanidino, substituted guanidino, hydroxy, hydroxyamino, alkoxyamino, hydrazino, substituted hydrazino, heteroaryl, substituted heteroaryl, heteroaryloxy, substituted heteroaryloxy, heteroarylthio, substituted heteroarylthio, heterocyclic, substituted heterocyclic, heterocyclyloxy, substituted heterocyclyloxy, heterocyclylthio, substituted heterocyclylthio, nitro, oxo, thione, spirocycloalkyl, phosphate, phosphonate, phosphinate, phosphonamidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, and substituted alkylthio.

In one particular embodiment, for instance, the hydrocarbon polymer may be a homopolymer formed from an aliphatic olefin, such as ethylene, propylene, butene, pentene, hexene, heptene, octene, etc., as well as combinations thereof. Propylene and/or butene (e.g., 1-butene) may be particularly suitable. If desired, one or more carbon atoms of the aliphatic olefin polymer may optionally be substituted as described above. For example, the polymer may be substituted with a “(meth)acrylate” group, which is a term that encompasses acrylic and methacrylic groups, as well as salts or esters thereof, such as acrylate and methacrylate groups. Examples of such (meth)acrylates may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one embodiment, for example, the resinous material may include a homopolymer in which the main chain is derived from butyl and substituted with (meth)acrylate (e.g., poly(butyl-methacrylate).

Another suitable type of a hydrocarbon homopolymer may be one in which the main chain is derived from a cyclic and/or heterocyclic olefin, such as described above. In one embodiment, for example, the main chain may be derived from dioxane (e.g., 1,4-dioxane). If desired, one or more carbon atoms of the cyclic olefin or heterocyclic olefin polymer may optionally be substituted as described above. For example, the polymer may be substituted with an alkyl group, such as methyl, ethyl, propyl, butyl, pentyl, heptyl, hexyl, etc. In one embodiment, for example, the resinous material may include a homopolymer in which the main chain is derived from a dioxane and substituted with propyl (e.g., polyvinyl butyrate) or derived from cyclohexyl and substituted with (meth) acrylate (e.g., poly(cyclohexylacrylate).

Apart from homopolymers, hydrocarbon copolymers may also be employed. In one embodiment, for example, the copolymer (e.g., block copolymer) may contain two or more monoalkenyl arene components separated by at least one saturated conjugated diene component. The monoalkenyl arene component(s) may, for example, include styrene, o-methyl styrene; p-methyl styrene, p-tert-butyl styrene; 1,3 dimethyl styrene p-methyl styrene; etc. The conjugated diene component(s) may include homopolymers of conjugated diene monomers, copolymers of two or more conjugated dienes, and copolymers of one or more of the dienes with another monomer in which the blocks are predominantly conjugated diene units. For example, the conjugated dienes may include 1,3 butadiene (butadiene); 2-methyl-1,3 butadiene; isoprene; 2,3 dimethyl-1,3 butadiene; 1,3 pentadiene (piperylene); 1,3 hexadiene; and so forth. Particularly suitable copolymers may include styrene-diene block copolymers, such as styrene-butadiene, styrene-isoprene, styrene-butadiene-styrene, and styrene-isoprene-styrene, styrene-olefin block copolymers formed by selective hydrogenation of styrene-diene block copolymers, etc. Examples of such styrene-olefin block copolymers include styrene-(ethylene-butylene), styrene-(ethylene-propylene), styrene-(ethylene-butylene)-styrene, styrene-(ethylene-propylene)-styrene, styrene-(ethylene-butylene)-styrene-(ethylene-butylene), styrene-(ethylene-propylene)-styrene-(ethylene-propylene), and styrene-ethylene-(ethylene-propylene)-styrene.

The resinous material has a per-and polyfluoroalkyl substance content of about 50 ppm or less. For instance, in certain embodiments, the hydrocarbon polymer may be generally free of any fully fluorinated carbon atom, such as a fully fluorinated methyl (CF₃—) or methylene (—CF₂—) carbon atom without any hydrogen, chlorine, bromine, and/or iodine attached. In some embodiments, the hydrocarbon polymer may be generally free of any sp³ carbon that has covalent bonds to at least two fluorine atoms.

In other embodiments, the hydrocarbon polymer is generally free of any fully fluorinated methyl carbon (without any hydrogen, chlorine, bromine and/or iodine atom attached to it). In other alternative or additional embodiments, the hydrocarbon polymer may contain one fully fluorinated (e.g., contiguous perfluorinated) methylene group. In preferred embodiments, the hydrocarbon polymer is generally free of any fully fluorinated methylene groups.

Thus, the hydrocarbon polymer may be generally free of a fluorinated aliphatic substance that has a fully fluorinated methyl or methylene carbon atom, a non-fluorinated aromatic ring with fluorinated aliphatic side-chain(s) that have a fully fluorinated methyl or methylene carbon atom, and/or a fluorinated aromatic ring with fluorinated aliphatic side chain(s) that have a fully fluorinated methyl or methylene carbon atom. In certain embodiments, the hydrocarbon polymer is generally free of any substances that have the chemical formula(s) of R—(CF₂)—CF(R′)R″, wherein both the CF₂ and CF moieties are saturated carbons, R—CF₂OCF₂-R′, where R and R′ can be either F, O, or saturated carbons, and/or CF₃C(CF₃)R′R″, where R′ and R″ can either be F or saturated carbons.

However, in other embodiments, the hydrocarbon polymer may include a fully fluorinated methyl or methylene carbon atom without any hydrogen, chlorine, bromine, and/or iodine attached if the hydrocarbon polymer has a structural element that includes CF₃—X or X—CF₂—X′ where X is —OR or —NRR′ and X′ is a methyl, methylene, aromatic group, carbonyl group, —OR″, —SR′, or —NR″R″′, and where R/R′/R″/R″′ is a hydrogen, methyl, methylene, aromatic group, or carbonyl group. Likewise, in certain embodiments, the hydrocarbon polymer may contain a fluorine atom that is directly bonded to a sp² or sp carbon.

Thus, in some embodiments, the hydrocarbon polymer is generally free of per- and polyfluoroalkyl substances, including, but not limited to, perfluoroalkyl acids (e.g., perfluoroalkyl carboxylic acid, perfluoroalkane sulfonic acid, perfluoroalkyl phosphonic acid, perfluoralkyl phosphinic acid, perfluoroalkylether carboxylic acid, perfluoroalkylether sulfonic acid, perfluoroalkyl dicarboxylic acid, perfluoroalkane disulfonic acid, perfluoroalkane sulfinic acid, etc.), polyfluoroalkyl acids (e.g., polyfluoroalkyl carboxylic acid, polyfluoroalkylether carboxylic acid, polyfluoroalkylether sulfonic acid, etc.,) polyfluoroalkyl acid precursors (e.g., fluorotelomer alcohols, perfluoroalkanoyl fluorides, perfluoroalkyl iodines, perfluoroalkane sulfonyl fluorides, perfluoroalkylether non-polymers, perfluoroalkylether side-chain fluorinated polymers, perfluoroalkenes, semifluorinated alkanes, hydrofluorocarbons, hydrofluoroethers, hydrofluoroolefins, perfluoroalkyl and semi-fluorinated ketones, perfluoroalkyl alcohols, etc.), fluoropolymers perfluoropolyethers, side-chain fluorinated aromatics, perfluoroalkanes, perfluoroalkyl-tert-amines, perfluoroalkylethers, or a combination thereof.

Further, although not required, it is typically desired that any substitutions of the hydrocarbon polymer are generally free of halogen atoms (e.g., fluorine, chlorine, bromine, etc.). In preferred embodiments, it is desired that any substitutions of the hydrocarbon polymer are generally free of fluorine atoms.

To help aid in its application, the barrier coating may be initially provided in the form of a coating formulation that contains the resinous material in combination with an organic solvent, which is typically a liquid at room temperature. When employed, such solvents typically constitute from about 70 wt. % to about 99.9 wt. %, in some embodiments from about 80 wt. % to about 99.8 wt. %, and in some embodiments, from about 90 wt. % to about 99.5 wt. % of the formulation, while the resinous material may constitute from about 0.1 wt. % to about 30 wt. %, in some embodiments from about 0.2 wt. % to about 20 wt. %, and in some embodiments, from about 0.5 wt. % to about 10 wt. % of the solution. The solvent(s) employed will depend in part on the nature of the resinous material, but generally include organic alcohols, hydrocarbon solvents, isoparaffinic solvents, mineral spirits, etc. For example, particularly suitable solvents for use with olefin polymers may include hydrocarbon solvents, such as aromatic hydrocarbons (e.g., xylene, toluene and ethylbenzene); cyclic hydrocarbons, such as alicyclic hydrocarbons (e.g., cyclohexane, cyclohexene and methylcyclohexane); aliphatic hydrocarbons (e.g., hexane, heptane, octane and decane); etc., as well as a combination thereof. Alicyclic hydrocarbons are particularly suitable for use in the coating formulation.

In certain embodiments, the solvent may be substantially free of halogen compounds. For instance, the solvent may include about 5 wt. % or less of a halogen compound, such as about 4 wt. % or less of a halogen compound, such as about 3 wt. % or less of a halogen compound, such as about 2 wt. % or less of a halogen compound, such as about 1 wt. % or less of a halogen compound, and even such as about 0.5 wt. % or less of a halogen compound based on the weight of the solvent. Thus, in some embodiments, the solvent does not include a fluorinated solvent. For instance, although not required, in some embodiments, the solvent is free of per-and polyfluoroalkyl substances, such as perfluoroalkyl acids having the formula CnF₂n+1−R (e.g., perfluoroalkyl carboxylic acids, perfluoroalkane sulfuric acids, perfluoroalkyl phosphonic acids, perfluoroalkyl phosphinic acids, etc.), perfluoroalkyl iodides, perfluoroalkane sulfonyl fluorides, and/or non-functionalized fluorinated carbon chains.

Further, in other embodiments, the formulation may be substantially free of halogens, such that the formulation includes about 0 wt. % to about 5 wt. % of a halogen compound, such as about 0.05 to about 3.5 wt. % of a halogen compound, such as about 0.1 to about 2 wt. % of a halogen compound based on the total weight of the formulation.

In certain other embodiments, the resinous material is substantially free of silicon-based compounds (e.g., silanes and/or siloxanes). For instance, in certain embodiments the resinous material comprises about 0 wt. % to about 5 wt. % of a silicon-based compound, such as about 0.1 wt. % to about 4 wt. % of a silicon-based compound, such as about 0.5 to about 2.5 wt. % of a silicon-based compound based on the total weight of the resinous material.

The coating formulation may be applied using a variety of known techniques, such as by spin coating, impregnation, pouring, dropwise application, injection, spraying, doctor blading, brushing, printing (e.g., ink-jet, screen, or pad printing), or dipping. Regardless, once applied, the coating formulation may be dried, heated, and/or cured to remove any remaining solvent(s) and leave a coating of the resinous material at the desired location.

Other additional compounds that may be utilized in the resinous material include, but are not limited to, corrosion inhibitors, antioxidants, plasticizers, acid scavengers, UV dyes, pigments, dispersing agents, molecular defoamers, waxes, wetting agents, adhesion promoters, coalescing agents, or a combination thereof.

### IV. Casing Material

As indicated, the capacitor element and anode lead are generally encapsulated with a casing material so that at least a portion of the anode and cathode terminations are exposed for mounting onto a circuit board. Referring again to FIGS. 1-3, for instance, the capacitor element 33 and anode lead 16 may be encapsulated within a casing material 28 so that a portion of the anode termination 62 and a portion of the cathode termination 72 remain exposed. Further, as noted above, at least a portion of the casing material 28 is also in contact with the barrier coating 90.

The casing material may be formed from a wide variety of materials. In one embodiment, for instance, the casing material may be formed from a curable resinous matrix, which may be hydrophobic. Thus, in some embodiments, the casing is typically formed from a thermoset resin. Examples of such resins include, for instance, epoxy resins, polyimide resins, melamine resins, urea-formaldehyde resins, polyurethane resins, phenolic resins, polyester resins, etc. Epoxy resins are also particularly suitable.

The casing material may also contain an inorganic oxide filler. Such fillers are typically maintained at a high level of the casing material, such as from about 75 wt. % to about 99.5 wt. %, in some embodiments from about 76 wt. % to about 99 wt. %, and in some embodiments, from about 77 wt. % to about 90 wt. % of the casing material, while the resinous matrix typically constitutes from about 0.5 wt. % to about 25 wt. %, in some embodiments from about 1 wt. % to about 24 wt. %, and in some embodiments, from about 10 wt. % to about 23 wt. % of the casing material. The nature of the inorganic oxide fillers may vary, such as silica, alumina, zirconia, magnesium oxides, iron oxides (e.g., iron hydroxide oxide yellow), titanium oxides (e.g., titanium dioxide), zinc oxides (e.g., boron zinc hydroxide oxide), copper oxides, zeolites, silicates, clays (e.g., smectite clay), etc., as well as composites (e.g., alumina-coated silica particles) and mixtures thereof. Regardless of the particular fillers employed, however, a substantial portion, if not all, of the inorganic oxide fillers is typically in the form of vitreous silica, which is believed to further improve the resistance of the casing material to thermal expansion due to its high purity and relatively simple chemical form. Vitreous silica may, for instance, constitute about 30 wt. % or more, in some embodiments from about 35 wt. % to about 90 wt. %, and in some embodiments, from about 40 wt. % to about 80 wt. % of the total weight of fillers employed in the composition, as well as from about 20 wt. % to about 70 wt. %, in some embodiments from about 25 wt. % to about 65 wt. %, and in some embodiments, from about 30 wt. % to about 60 wt. % of the entire composition. Of course, other forms of silica may also be employed in combination with the vitreous silica, such as quartz, fumed silica, cristabolite, etc.

Apart from the components noted above, it should be understood that still other additives may also be employed in the casing material, such as photoinitiators, viscosity modifiers, suspension aiding agents, pigments, stress reducing agents, coupling agents (e.g., silane coupling agents), stabilizers, etc. When employed, such additives typically constitute from about 0.1 to about 20 wt. % of the total composition.

The particular manner in which the casing material is applied to the capacitor element may vary as desired. In one particular embodiment, the capacitor element is placed in a mold and the casing material is applied to the capacitor element so that it occupies the spaces defined by the mold and leaves exposed at least a portion of the anode and cathode terminations. The casing material may be initially provided in the form of a single or multiple compositions. For instance, a first composition may contain the resinous matrix and filler and the second composition may contain a co-reactant. Regardless, once it is applied, the casing material may be heated or allowed to stand at ambient temperatures so that the resinous matrix is allowed to crosslink with the co-reactant, which thereby causes the casing material to cure and harden into the desired shape of the case. For instance, the casing material may be heated to a temperature of from about 15° C. to about 150° C., in some embodiments from about 20° C. to about 120° C., and in some embodiments, from about 25° C. to about 100° C.

The following test methods may be used to determine the properties referenced in the description above, as well as in the Examples.

### Test Methods

### Equivalent Series Resistance (ESR)

Equivalence series resistance may be measured using a Keithley 3330 Precision LCZ meter with Kelvin Leads 2.2 volt DC bias and a 0.5 volt peak to peak sinusoidal signal. The operating frequency may 100 kHz and the temperature may be 23° C.±2° C.

### Leakage Current (DCL)

Leakage current may be measured using a leakage test meter at a temperature of 23° C.±2° C. and at the rated voltage after a minimum of 60 seconds.

### Moisture Sensitivity Level (MSL) Testing

MSL may be tested on 25-50 capacitor units according to IPC/JEDEC J-STD-020F (December 2022) to Level 3 with reflow for Pb-free assembly. Reflow peak temperature (Tp) may be 260° C. Visual evaluation of cracks may be measured with 40 times magnification.

### Dynamical Mechanical Analysis (“DMA”)

Dynamical Mechanical Analysis may be performed according to ASTM D4065-20 standard on a Anton Parr MCR 702 DMA/Rheometer. The sample may be loaded in between 20 mm parallel plate-shaped fixtures on a torsional setting. The test may be performed with 0.5% strain, 1 Hz frequency and 1N normal force. The test may be performed inside a furnace under Nitrogen flow with a temp ramping rate at 1~10° C. The first testing cycle may be ramped up to 200° C. to capture storage modulus (G′) and loss modulus (G″) data. The gelation point may be determined by the point where G″ started to go over G′ and remain the same way until the end of the test. The second testing cycle may be ramped up to 270° C. to capture complex viscosity data and reported as log value.

### Thermogravimetric Analysis (“TGA”)

Thermogravimetric analysis may be tested according to ASTM E1131 standard. The sample is loaded in a sample holder and placed in a testing chamber protected with Nitrogen atmosphere. The chamber may be heated up to 150° C. and cooled down to room temperature to drive away residual solvents. Then the temperature of the testing chamber may be ramped up to 500~900° C. or until the sample is completely decomposed. The temperature ramping rate may be 1~10° C./min during the test. The thermal decomposition temperature is determined as the temperature when the material loses 5% of its starting mass.

### Contact Angle

Contact angle may be tested according to ASTM D5946 standard. Glass substrates may be cut to desired dimensions (16×25 mm) and cleaned (acetone, IPA, dried by N2 gas) prior to use. Films may be made by drop casting 200 μL of desired test solutions over the glass substrate. Samples are dried at room temperature for 24 hours at ambient conditions before a 1 hour, 70° C. bake. Prior to testing, samples may be conditioned at 23±2° C., 50±10% RH for 40 hours. An Ossila Contact Angle goniometer may be used, equipped with a 1920×1080 high-resolution camera, a backlight source, and an adjustable sample stage. A high-precision 25 μL syringe may be used with the dispensed liquid being DI-H2O. The image may be analyzed by the Ossila Contact Angle software suite, operated on version 4.2.1.

The present invention may be better understood with reference to the following examples.

### COMPARATIVE EXAMPLE 1

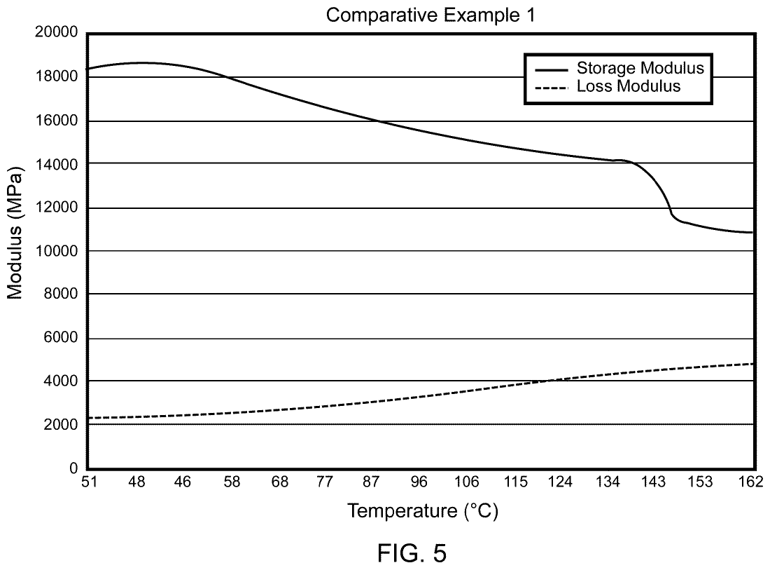

40,000 uFV/g tantalum powder was used to form anode samples. Each anode sample was embedded with a tantalum wire, pressed to a density of 5.3 g/cm³ and sintered at 1380° C. The resulting pellets had a size of 5.20×3.60×0.80 mm. The pellets were anodized to 79.0 volts in water/phosphoric acid electrolyte with a conductivity of 8.6 mS at a temperature of 40° C. to form the dielectric layer. The pellets were anodized again to 130 volts in a water/boric acid/disodium tetraborate with a conductivity of 2.0 mS at a temperature of 30° C. for 10 seconds to form a thicker oxide layer built up on the outside. A conductive polymer coating was formed by dipping the anodes into a solution of poly (4-(2,3-dihydrothieno-[3,4-b][1,4]dioxin-2-ylmethoxy)-1-butane-sulphonic acid having a solids content of 2.0% (Clevios™ K, Heraeus). Upon coating, the parts were dried at 125° C. for 15 minutes. This process was repeated 2 times. Thereafter, the parts were dipped into a dispersed poly (3,4-ethylenedioxythiophene) having a solids content 1.1% and viscosity 20 mPa·s (Clevios™ K, Heraeus). Upon coating, the parts were dried at 125° C. for 15 minutes. This process was repeated 8 times. Thereafter, the parts were dipped into a dispersed poly (3,4-ethylenedioxythiophene) having a solids content 2.0% and viscosity 20 mPa·s (Clevios™ K, Heraeus). Upon coating, the parts were dried at 125° C. for 15 minutes. This process was repeated 3 times. Thereafter, the parts were dipped into a dispersed poly (3,4-ethylenedioxythiophene) having a solids content of 2% and viscosity 160 mPa·s (Clevios™ K, Heraeus). Upon coating, the parts were dried at 125° C. for 15 minutes. This process was repeated 14 times. The parts were then dipped into a graphite dispersion and dried. Finally, the parts were dipped into a silver dispersion and dried. A barrier coating including a polyolefin resinous material in a methyl-cyclohexane solvent was disposed on the capacitor element. The coated capacitor elements were then encapsulated in a silica resin to make 47 μF/35V capacitors. The resulting capacitor had a size of 7.30×4.30×1.50 mm. The barrier coating was subjected to DMA and TGA testing as described above. The DMA curve of the barrier coating of Comparative Example 1 is demonstrated by FIG. 5.

### COMPARATIVE EXAMPLE 2

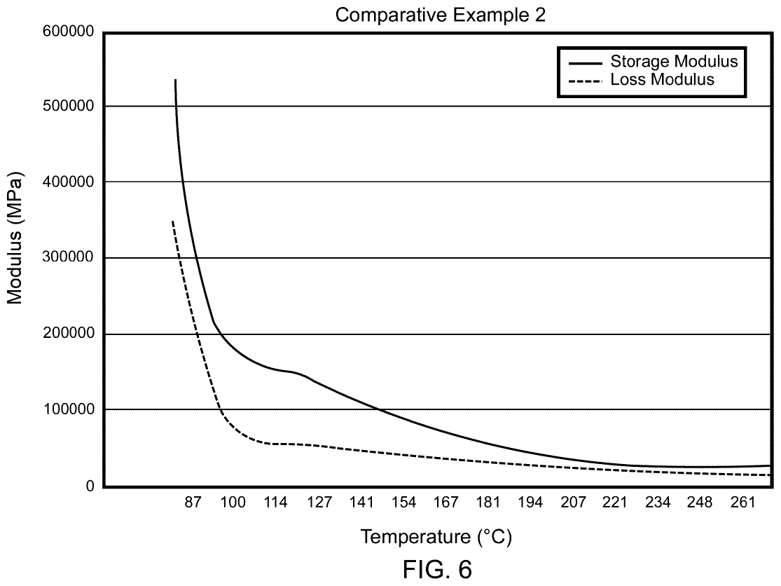

Capacitors were formed in the manner described in Comparative Example 1, except that the barrier coating included a polyvinyl butyral resinous material in an ethanol solvent. The barrier coating was subjected to DMA and TGA testing as described above. The DMA curve of the barrier coating of Comparative Example 2 is demonstrated by FIG. 6.

### COMPARATIVE EXAMPLE 3

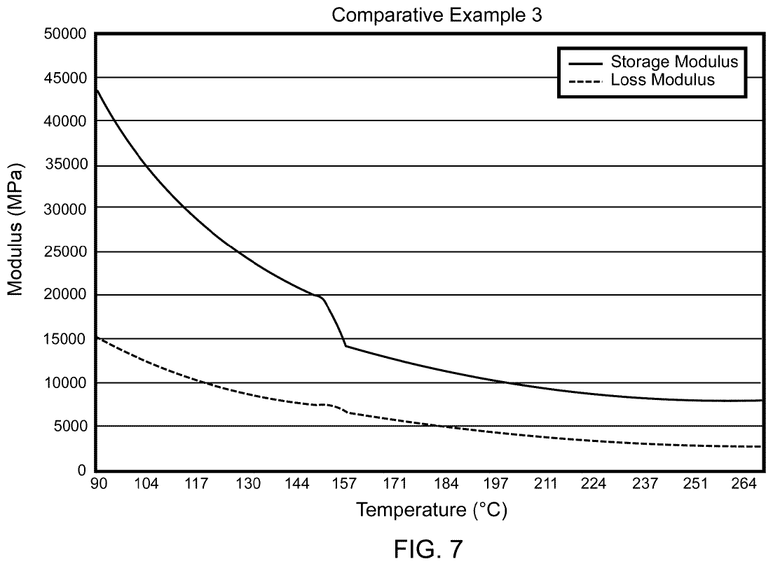

Capacitors were formed in the manner described in Comparative Example 1, except that the barrier coating included a separate polyolefin resinous material in a methyl-cyclohexane solvent. The barrier coating was subjected to DMA and TGA testing as described above. The DMA curve of the barrier coating of Comparative Example 3 is demonstrated by FIG. 7.

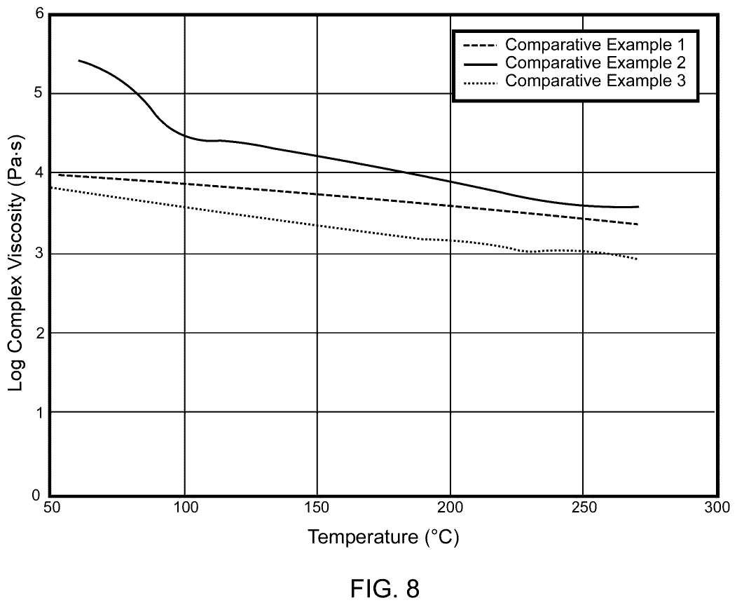

The log complex viscosities were determined for the barrier coatings of Comparative Examples 1-3 over a temperature range of about 50° C. to about 270° C. The log complex viscosities of the barrier coatings of Comparative Examples 1-3 are demonstrated by FIG. 8.

Other properties of Comparative Examples 1-3 obtained during the DMA and TGA testing are set forth below in Table 1.

TABLE 1
Comparative Example DMA/TGA Test Results

| Comparative | | | Contact | Gelation |
|---|---|---|---|---|
| Example | T_{g} (° C.) | T_{d} (° C.) | Angle (°) | Point (° C.) |
| 1 | 44-47 | 240 | 105 | > |
| 2 | 75-77 | 270 | 91 | > |
| 3 | 46-53 | 240 | 103 | > |

As demonstrated by Table 1 and FIGS. 5-7, the gelation points for Comparative Examples 1-3 were higher than the tested temperature ranges.

The moisture sensitivity level was tested for capacitors prepared according to Comparative Examples 1-3. Moisture sensitivity level was tested after 192 hours (MSL3) according to IPC/JEDEC J-STD 020E (December 2014). The percentage of the cracked parts is set forth below in Table 2. The sample size was 100 units minimum for each humidification time.

TABLE 2
Comparative Example MSL3 Results

| Comparative Example | MSL3 (% of cracked units) |
|---|---|
| 1 | 48 |
| 2 | 85 |
| 3 | 68 |

Other electrochemical parameters of the capacitors prepared according to Comparative Examples 1-3 are demonstrated below in Table 3.

TABLE 3
Comparative Example DCL and ESR Results

| | Before MSL3 Testing | | After MSL3 Testing | |
|---|---|---|---|---|
| Comparative | DCL | ESR | DCL | ESR |
| Example | (μA) | (mOhm) | (μA) | (mOhm) |
| 1 | 5.09 | 58.5 | 6.15 | 60.9 |
| 2 | 5.09 | 71.2 | 4.22 | 81.1 |
| 3 | 4.35 | 56.8 | 5.23 | 63.0 |

### EXAMPLE 1

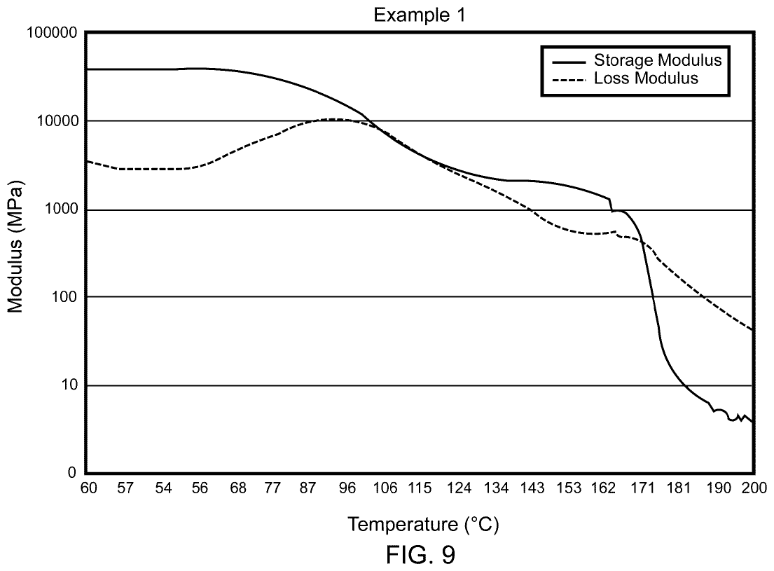

Capacitors were formed in the manner described in Comparative Example 1, except that the barrier coating included styrene-ethylene/butylene-styrene resinous material in a methyl-cyclohexane solvent. The barrier coating was subjected to DMA and TGA testing as described above. The DMA curve of the barrier coating of Example 1 is demonstrated by FIG. 9.

### EXAMPLE 2

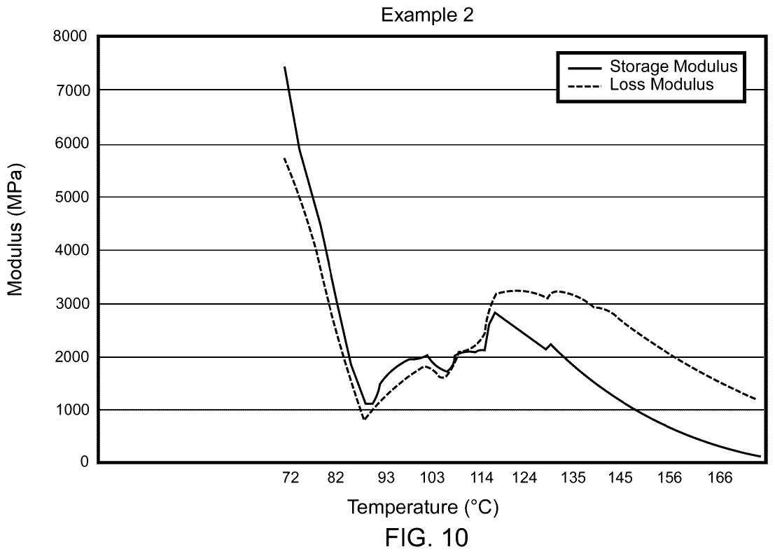

Capacitors were formed in the manner described in Comparative Example 1, except that the barrier coating included polyvinyl butyral resinous material in an ethanol solvent. The barrier coating was subjected to DMA and TGA testing as described above. The DMA curve of the barrier coating of Example 2 is demonstrated by FIG. 10.

### EXAMPLE 3

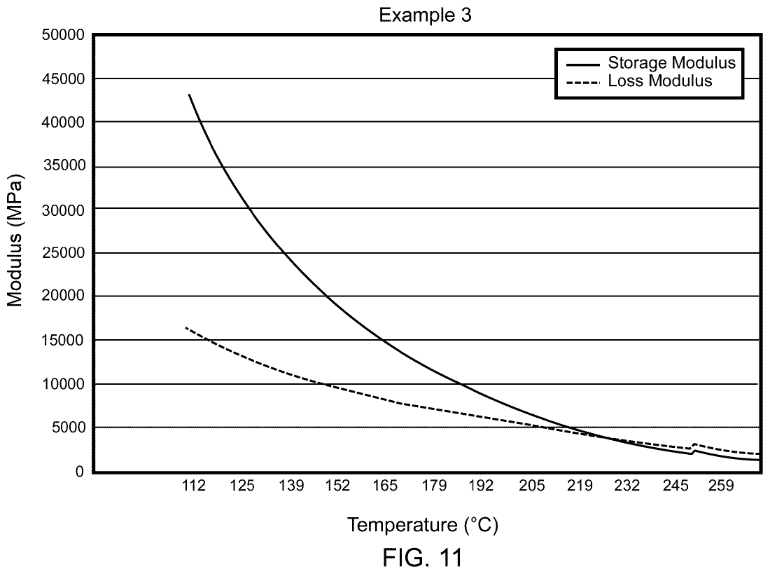

Capacitors were formed in the manner described in Comparative Example 1, except that the barrier coating included polyvinyl butyral resinous material in an ethanol solvent. The barrier coating was subjected to DMA and TGA testing as described above. The DMA curve of the barrier coating of Example 3 is demonstrated by FIG. 11.

### EXAMPLE 4

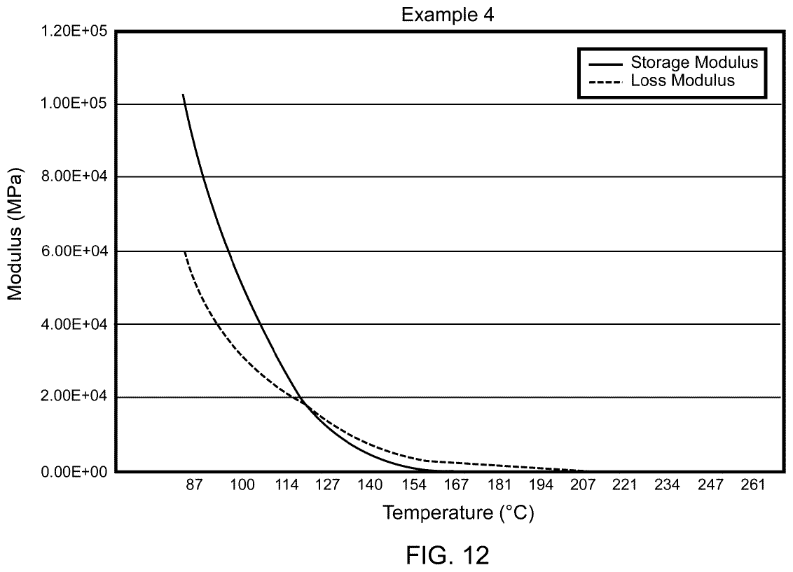

Capacitors were formed in the manner described in Comparative Example 1, except that the barrier coating included poly (butyl-methacrylate) resinous material in a fluorinated solvent. The barrier coating was subjected to DMA and TGA testing as described above. The DMA curve of the barrier coating of Example 4 is demonstrated by FIG. 12.

### EXAMPLE 5

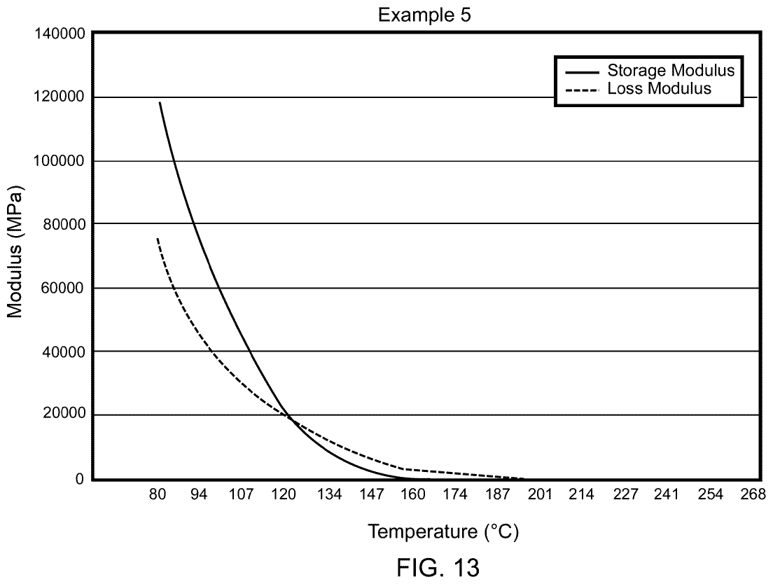

Capacitors were formed in the manner described in Comparative Example 1, except that the barrier coating included poly (butyl-methacrylate) resinous material in a fluorinated solvent. The barrier coating was subjected to DMA and TGA testing as described above. The DMA curve of the barrier coating of Example 5 is demonstrated by FIG. 13.

### EXAMPLE 6

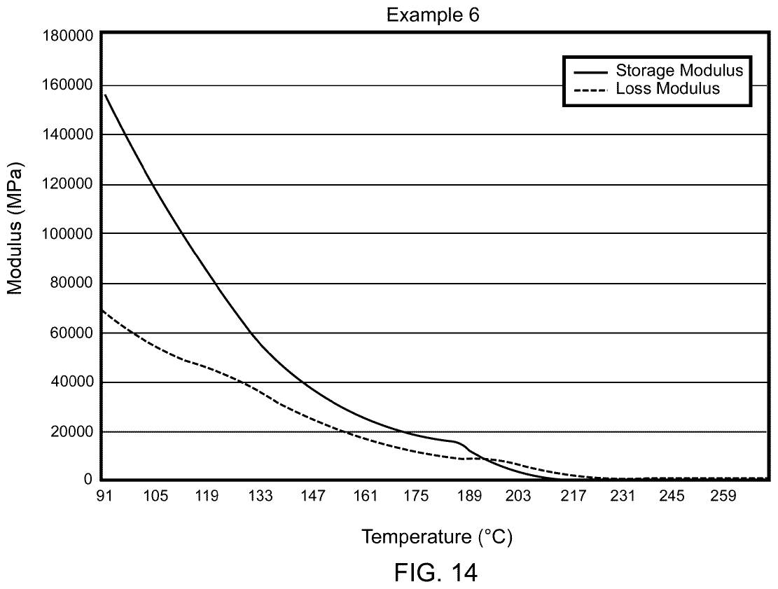

Capacitors were formed in the manner described in Comparative Example 1, except that the barrier coating included styrene-ethylene/butylene-styrene resinous material in a methyl-cyclohexane solvent. The barrier coating was subjected to DMA and TGA testing as described above. The DMA curve of the barrier coating of Example 6 is demonstrated by FIG. 14.

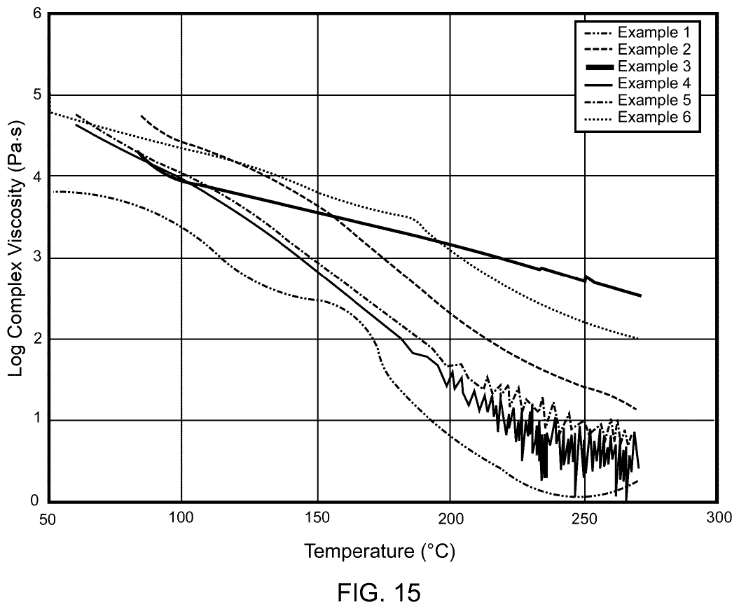

The log complex viscosities were determined for the barrier coatings of Examples 1-6 over a temperature range of about 50° C. to about 270° C. The log complex viscosities of the barrier coatings of Examples 1-6 are demonstrated by FIG. 15.

Other properties of Examples 1-6 obtained during the DMA and TGA testing are set forth below in Table 4.

TABLE 4
Example DMA/TGA Test Results

| | | | Contact | Gelation |
|---|---|---|---|---|
| Example | T_{g} (° C.) | T_{d} (° C.) | Angle (°) | Point (° C.) |
| 1 | 45-47 | 250 | 101 | 176 |
| 2 | 66-70 | 270 | 105 | 138 |
| 3 | 65-67 | 270 | 80 | 80 |
| 4 | 42 | 220 | 108 | 120 |
| 5 | 50 | 215 | 92 | 123 |
| 6 | > | 310 | 80 | 182 |

The moisture sensitivity level was tested for capacitors prepared according to Examples 1-6. Moisture sensitivity level was tested after 192 hours (MSL3) according to IPC/JEDEC J-STD 020E (December 2014). The percentage of the cracked parts is set forth below in Table 5. The sample size was 100 units minimum for each humidification time.

TABLE 5
Example MSL3 Results

| Example | MSL3 (% of cracked units) |
|---|---|
| 1 | 0 |
| 2 | 27 |
| 3 | 31 |
| 4 | 0 |
| 5 | 0 |
| 6 | 16 |

Other electrochemical parameters of the capacitors prepared according to Examples 1-6 are demonstrated below in Table 6.

TABLE 6
Example DCL and ESR Results

| | |
|---|---|
| Before MSL3 Testing | After MSL3 Testing |

| | DCL | ESR | DCL | ESR |
|---|---|---|---|---|
| Example | (μA) | (mOhm) | (μA) | (mOhm) |
| 1 | 5.37 | 56.7 | 6.51 | 59.2 |
| 2 | 7.06 | 85.4 | 7.69 | 97.0 |
| 3 | 5.52 | 78.6 | 6.22 | 81.7 |
| 4 | 5.22 | 61.6 | 6.39 | 59.1 |
| 5 | 5.19 | 62.3 | 6.15 | 58.2 |
| 6 | 4.56 | 55.7 | 5.52 | 60.7 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A solid electrolytic capacitor comprising:
a capacitor element that contains an anode body, a dielectric that overlies the anode body, and a solid electrolyte that overlies the dielectric;
an anode lead extending from a surface of the capacitor element;
an anode termination that is in electrical connection with the anode lead and a cathode termination that is in electrical connection with the solid electrolyte;
a casing material that encapsulates the capacitor element and anode lead; and
a barrier coating that is disposed adjacent to at least a portion of the cathode termination and/or anode termination, wherein the barrier coating comprises a resinous material containing a hydrocarbon polymer, wherein the resinous material has a per-and polyfluoroalkyl substance content of about 50 ppm or less and a gelation point of from about 60° C. to about 250° C.

2. The solid electrolytic capacitor of claim 1, wherein the gelation point is from about 80° C. to about 200° C.

3. The solid electrolytic capacitor of claim 1, wherein the hydrocarbon polymer comprises a monomeric component that includes from about 2 to about 20 carbon atoms.

4. The solid electrolytic capacitor of claim 3, wherein the monomeric component comprises a cyclic olefin and/or a heterocyclic olefin.

5. The solid electrolytic capacitor of claim 4, wherein the cyclic olefin is substituted with a (meth)acrylate group.

6. The solid electrolytic capacitor of claim 4, wherein the heterocyclic olefin includes a dioxane.

7. The solid electrolytic capacitor of claim 3, wherein the monomeric component comprises an aliphatic olefin that is substituted with a (meth)acrylate group.

8. The solid electrolytic capacitor of claim 1, wherein the hydrocarbon polymer comprises a copolymer that includes two or more monoalkenyl arene components separated by at least one saturated conjugated diene component.

9. The solid electrolytic capacitor of claim 8, wherein the copolymer includes a styrene-(ethylene-butylene), styrene-(ethylene-propylene), styrene-(ethylene-butylene)-styrene, styrene-(ethylene-propylene)-styrene, styrene-(ethylene-butylene)-styrene-(ethylene-butylene), styrene-(ethylene-propylene)-styrene-(ethylene-propylene), styrene-ethylene-(ethylene-propylene)-styrene, or a combination thereof.

10. The solid electrolytic capacitor of claim 1, wherein the per-and polyfluoroalkyl substance includes a fully fluorinated carbon atom.

11. The solid electrolytic capacitor of claim 10, wherein the fully fluorinated carbon atom includes a fully fluorinated methyl or methylene without any hydrogen, chlorine, bromine, and/or iodine atoms attached.

12. The solid electrolytic capacitor of claim 1, wherein the resinous material has a halogen content of about 500 ppm or less.

13. The solid electrolytic capacitor of claim 1, wherein the hydrocarbon polymer is generally free of a per-and polyfluoralkyl substance.

14. The solid electrolytic capacitor of claim 13, wherein the per-and polyfluoralkyl substance includes a fully fluorinated carbon atom.

15. The solid electrolytic capacitor of claim 14, wherein the fully fluorinated carbon atom includes a fully fluorinated methyl or methylene without any hydrogen, chlorine, bromine, and/or iodine atoms attached.

16. The solid electrolytic capacitor of claim 1, wherein the resinous material has a log complex viscosity of about 3 or less at a temperature of from about 225° C. to about 270° C.

17. The solid electrolytic capacitor of claim 1, wherein the resinous material has a complex viscosity of about 200 Pa·s or less at a temperature of about 200° C. or more.

18. The solid electrolytic capacitor of claim 1, wherein the resinous material has a contact angle of about 75° or greater.

19. The solid electrolytic capacitor of claim 1, wherein the barrier coating is disposed adjacent to at least a portion of the cathode termination.

20. The solid electrolytic capacitor of claim 19, wherein the barrier coating is disposed adjacent to at least a portion of the capacitor element.

21. The solid electrolytic capacitor of claim 1, wherein the barrier coating is disposed adjacent to at least a portion of the anode termination.

22. The solid electrolytic capacitor of claim 1, wherein the barrier coating is disposed adjacent to at least a portion of the anode lead.

23. The solid electrolytic capacitor of claim 20, wherein the barrier coating is disposed adjacent to at least a portion of the anode termination.

24. The solid electrolytic capacitor of claim 1, wherein the capacitor exhibits a Moisture Sensitive Level of at least 3 when tested in accordance with J-STD-020E (December 2014).

25. A method for forming the solid electrolytic capacitor of claim 1, the method comprising:
disposing a coating formulation adjacent to at least a portion of the cathode termination and/or anode termination, the coating formulation containing a resinous material and a solvent; and
removing the solvent from the coating formulation to form the barrier coating.

26. The method of claim 25, wherein the solvent includes a hydrocarbon solvent.

27. The method of claim 25, wherein the solvent is substantially free of halogens.
